(19) United States
(12) Patent Application Publication
(10) Pub. No.: US 2014/0131380 A1
(43) Pub. Date: May 15, 2014

(54) LINER-BASED SHIPPING AND DISPENSING CONTAINERS

(71) Applicant: ATMI PACKAGING, INC., Bloomington, MN (US)

(72) Inventors: Vishwas PETHE, Shakopee, MN (US); Jeff CRAIG, Ballwin, MO (US); Don WARE, Woodbury, MN (US)

(73) Assignee: ATMI PACKAGING, INC., Bloomington, MN (US)

(21) Appl. No.: 14/039,847

(22) Filed: Sep. 27, 2013

Related U.S. Application Data
(63) Continuation of application No. PCT/US2012/030822, filed on Mar. 28, 2012.
(60) Provisional application No. 61/468,631, filed on Mar. 29, 2011.
(60) Provisional application No. 61/484,819, filed on May 11, 2011.
(60) Provisional application No. 61/590,139, filed on Jan. 24, 2012.
(60) Provisional application No. 61/549,338, filed on Oct. 20, 2011.
(60) Provisional application No. 61/468,555, filed on Mar. 28, 2011.
(60) Provisional application No. 61/468,551, filed on Mar. 28, 2011.
(60) Provisional application No. 61/590,151, filed on Jan. 24, 2012.

(51) Int. Cl. A61J 1/14

(52) U.S. Cl. CPC A61J 1/1443
USPC 222/1; 29/592; 222/95

(57) ABSTRACT

In one aspect, the present disclosure relates to the substantially sterile transport of a substantially sterile substance using a liner-based assembly having an overpack and a flexible or semi-rigid liner disposed within the overpack configured for pressure dispense, and a connector securable to at least one of the overpack or liner. The connector may include a first port operably connected with a quick connector configured for substantially aseptic filling of the liner. The first port may be configured for substantially aseptic sealing after filling of the liner. The connector may be configured for substantially aseptic dispense of the substance of the liner via the first port after unsealing of the first port or via a second port. In some particular embodiments, the second port may be operably connected with a quick connector, and dispense of the substance of the liner occurs via the quick connector of the second port. The assembly may include one or more of a mixer, a sparger, a sensor, or combinations thereof, and may be arranged to form a bioreactor. Related methods are also described.

This application claims the benefit of U.S. Provisional Patent Application Ser. Nos. 61/468,631, 61/468,555, 61/590,139, 61/468,551, 61/484,819, 61/549,338, and 61/590,151, the disclosures of which are each incorporated herein by reference in their entirety.

### FIELD OF THE INVENTION

The present disclosure relates to novel and advantageous shipping and dispensing systems. Particularly, the present disclosure relates to novel and advantageous disposable liner-based systems, for the substantially sterile storage, shipment, and dispense of materials used in the biotechnology and pharmaceutical industries.

### BACKGROUND OF THE INVENTION

Numerous materials, such as culture media, buffers, reagents and other biological materials, for example, are used extensively by biotech companies, in research and development, vaccine creation and usage, protein production and purification, and the development of other biologics. To be safe and effective for their intended use, as well as to be in compliance with various rules and regulations, these materials must be pure and sterile.

Container systems may be used in the biopharmaceutical, and other industries, for storing, shipping, mixing, reacting, processing, and/or dispensing materials such as those described above. Such materials are often fragile and/or expensive, and/or must be maintained in a sterile environment. Accordingly, any container system used with such materials must be substantially air-tight to prevent contamination and to prevent escape of the material into the outside environment. Further a container system must be safe, sterile, reliable and leak proof, such that it may withstand the stresses of shipping and dispense.

Container systems that are used to store and dispense the types of materials described above, as well as other liquid-based contents, typically include a container of some kind, and/or a liner, a cap that may be used to seal and protect the contents of the storage system when the contents are not being dispensed, and a connector that may be used to dispense the contents from the container. However, traditional storage and dispense container systems are typically not configured to permit for the safe and secure shipment of the types of materials described, particularly not in a disposable container system.

Accordingly, there is a need for a relatively inexpensive container system that may function as both a shipping container system, as well as a dispensing container system.

### BRIEF SUMMARY OF THE INVENTION

In one aspect, the disclosure pertains to a liner-based assembly for pressure dispensing a substantially sterile substance, the liner-based assembly comprising an overpack and a liner disposed within the overpack and arranged for receiving the substantially sterile substance under sterile conditions, the liner configured to collapse when a pressure is applied to a space adjacent to the liner (such as an annular space between the liner and the overpack). A connector securable to at least one of the overpack or liner comprises at least one port for providing the liner with the substantially sterile substance and for dispensing the substantially sterile substance upon application of the pressure, the at least one port being operably connected with a quick connector configured for at least one of substantially aseptic filling or dispensing of substantially sterile substance. The liner may be disposable, thus allowing for a single use.

In one embodiment, the liner is manufactured from material selected to substantially maintain the sterility of the substance stored within the liner. The connector may comprise a pressurizing gas inlet for operably connecting with a pressure source for supplying the applied pressure in the space. The quick connector may provide an aseptic connection, and the connector may comprise a port configured for both filling and dispensing of the substance. Specifically, the connector comprises a first port for filling liner with the substance and a second port for dispensing the substance from the liner.

A dip tube may be provided. The dip tube may have a first end operably secured to the liner by a top fitment located at a top portion of the liner and a second end operably secured to a bottom fitment located at a bottom of the liner. The bottom fitment may operably secure the second end of the dip tube such that the second end is statically secured at the bottom of the liner, or instead may be configured to permit the end of the dip tube attached thereto to move about at least one axis of motion.

In these or other embodiments, a mixer may be provided for mixing the substantially sterile substance in the liner. The mixer may comprise a flexible body, such as a sleeve having an open end connected to the liner. In one embodiment, the mixer comprises at least one magnet, which may be positioned in the sleeve.

A sparger may also be provided for supplying a gas to the substantially sterile substance in the liner. The sparger may be integrally formed with the liner, or may be adapted for moving within the liner. A vent may also be provided for venting gas from the liner, as well as a sensor for sensing a characteristic of the substance.

Another aspect of the disclosure relates to a method for substantially sterile transport of a substantially sterile substance. The method comprises providing a liner-based assembly comprising an overpack and a liner disposed within the overpack, the liner configured to collapse when a pressure is applied to an annular space between the liner and the overpack; and providing a connector securable to at least one of the overpack or liner, the connector comprising: a first port operably connected with a quick connector configured for substantially aseptic filling of the liner; wherein the first port is configured for substantially aseptic sealing after filling of the liner; and wherein the connector is configured for substantially aseptic dispense of the substance of the liner via the first port after unsealing of the first port or via a second port.

In one embodiment, the second port is operably connected with a quick connector, and dispense of the substance of the liner occurs via the quick connector of the second port. The method may comprise the step of irradiating at least one of the liner or connector, and may comprise the step of evacuating gas from the liner. The method may include the step of removing headspace gas from the liner subsequent filling of the liner with the substance.

The aseptic sealing of the first port may comprise sealing of a tube of the first port somewhere prior to the quick connect. The method may further include the step of unsealing of the first port by connecting the tube of the first port with a tube of a dispense receptacle using a sterile tube fuser. The connector further comprises a pressurizing gas inlet for operably connecting with a pressure source for supplying the applied pressure in the space.

The method may include the step of providing a mixer for mixing the substance in the liner. The method may include the step of providing a sparger for supplying a gas to the substance in the liner. The method may include the step of providing a sensor for sensing a characteristic of the substance. The step of mixing the substance in the liner, sparging the substance, and sensing a characteristic of the substance may also be performed.

A further aspect of the disclosure pertains to a liner-based assembly for pressure dispensing a substance, the liner-based assembly. The assembly may comprise an overpack; a liner disposed within the overpack and arranged for receiving the substance, the liner configured to collapse when a pressure is applied to a space adjacent to the liner; a connector securable to at least one of the overpack or liner, the connector comprising at least one port for providing the liner with the substantially sterile substance and for dispensing the substantially sterile substance upon application of the pressure; and a mixer for mixing the substance, said mixer being coupled to the liner.

The mixer may comprise a flexible body, such as a sleeve having an open end connected to the liner. The mixer may further comprise at least one magnet, which may be positioned in the sleeve. A sparger may be provided for supplying a gas to the substantially sterile substance in the liner, and may be adapted for moving within the liner. The assembly may further include a vent for venting a gas from the liner, or a sensor for sensing a characteristic of the substance.

Still a further aspect of the disclosure relates to a liner-based assembly for pressure dispensing a substance, the liner-based assembly comprising: an overpack; a liner disposed within the overpack and arranged for receiving the substance, the liner configured to collapse when a pressure is applied to a space adjacent to the liner; a connector securable to at least one of the overpack or liner, the connector comprising at least one port for providing the liner with the substance and for dispensing the substance upon application of the pressure; and a sparger for supplying gas to the substance in the liner.

In one embodiment, the sparger is adapted for moving within the liner. The assembly may include a mixer for mixing the substance, and the mixer may be connected to the sparger. The mixer may also be coupled to the liner, and may comprise a flexible body, such as a sleeve having an open end connected to the liner. The mixer may comprise at least one magnet, and the assembly may include a vent for venting a gas from the liner or a sensor for sensing a characteristic of the substance.

Yet another aspect of the disclosure pertains to a liner-based assembly for pressure dispensing a substance, the liner-based assembly comprising: an overpack; a liner disposed within the overpack and arranged for receiving the substance, the liner configured to collapse when a pressure is applied to a space adjacent to the liner; a connector securable to at least one of the overpack or liner, the connector comprising at least one port for providing the liner with the substance and for dispensing the substance upon application of the pressure; and a sensor for sensing a characteristic of the substance.

In one embodiment, the sensor is coupled to the liner. The assembly may further include a mixer for mixing the substance, which mixer may be connected to the sensor. The mixer may be coupled to the liner, and may comprise a flexible body (such as a sleeve having an open end connected to the liner). The mixer may comprise at least one magnet, and the assembly may include a sparger or a vent.

In any of the foregoing embodiments, the mixer may be external to the liner. In one example, the mixer comprises an agitator connected to the overpack and arranged to contact an outer surface of the liner to mix the substantially sterile substance. In another embodiment, the mixer comprises a bladder arranged to contact an outer surface of the liner to mix the substantially sterile substance. The overpack may include a pressurizing inlet and a vent, which together with a pressure source may be used to provide a controlled cycle of pressurization and depressurization resulting in compression and relaxation of the liner that cause the contents of the liner to mix.

Another aspect of the invention relates to a method for mixing a substance in a liner in an overpack while maintaining the substance under sterile conditions, comprising providing a mixer in a space between the liner and the overpack. The mixer may comprise an agitator for causing movement of the liner relative to the overpack. The agitator may comprise a block or an inflatable bladder, and the method may comprise moving the actuator in a vertical direction or moving the actuator toward the center of the overpack. The method may also comprise the step of mixing the substance using the mixer, and the step of sealing the substance in the liner during the mixing step. The method may further include the step of dispensing the substance from the liner after the mixing step is completed.

Yet a further aspect of the disclosure pertains to a liner-based assembly for pressure dispensing a substantially sterile substance, the liner-based assembly comprising an overpack including a pressure inlet and a closable vent. A liner is disponse within the overpack and arranged for receiving the substantially sterile substance under sterile conditions. The liner is configured to collapse when a pressure is applied to a space adjacent to the line via the pressure inlet, and relax when the pressure is relieved by the opening of the vent, in order to cause mixing of the substance. The liner may include a port that is closed until after the mixing is complete, at which point the port may be used to dispense the substance by pressurizing the space.

The disclosure also relates to a liner-based assembly for pressure dispensing a substantially sterile substance, the liner-based assembly comprising a liner disposed within the overpack and arranged for receiving the substantially sterile substance under sterile conditions, the liner configured to collapse when a pressure is applied to a space adjacent to the liner. A coiled dip tube is positioned in the liner.

A further aspect of the disclosure is a method for substantially sterile transport of a substantially sterile substance, the method comprising: providing a liner-based assembly comprising an overpack and a liner disposed within the overpack, the liner configured to collapse when a pressure is applied to an annular space between the liner and the overpack; and providing a connector securable to at least one of the overpack or liner, the connector comprising: a first port operably connected with a first quick connector configured for substantially aseptic filling of the liner; a second port operably connected with a second quick connector configured for the substantially aseptic dispense of the substance of the liner.

### BRIEF DESCRIPTION OF THE DRAWINGS

While the specification concludes with claims particularly pointing out and distinctly claiming the subject matter that is regarded as forming the various embodiments of the present disclosure, it is believed that the disclosure will be better understood from the following description taken in conjunction with the accompanying figures, in which:

FIG. 1 is a partial cut-away view of a shipping and dispensing system, according to one embodiment of the present disclosure.

FIG. 2 is a cross-sectional view of a shipping and dispensing system of the present disclosure, according to another embodiment.

FIG. 3 is an exploded view of a shipping and dispensing system, according to yet another embodiment of the present disclosure.

FIG. 4 is a cross-sectional view of a container system, including a container, a liner, and a connector, according to one embodiment of the present disclosure.

FIG. 5a is a perspective view of a container system, according to one embodiment of the present disclosure.

FIG. 5b is a partial cut-away view of the container system of FIG. 5b after the quick connect has been removed, according to one embodiment of the present disclosure.

FIG. 6a is a partial cut-away view of another container system, according to one embodiment of the present disclosure.

FIG. 6b is a partial cut-away view of the container system of FIG. 6a with one of the quick connects removed, according to one embodiment of the present disclosure.

FIG. 7 is a partial cut-away view illustrating pressure dispense of the container system, according to one embodiment of the present disclosure.

FIGS. 7a-7d illustrate the use of a controlled cycle of pressurization and depressurization resulting in compression and relaxation of the liner that may cause the contents of the liner to mix.

FIG. 8 is a perspective view of the container system including a shipping ring, according to one embodiment of the present disclosure.

FIG. 9 is a perspective view of a liner with a dip tube, according to one embodiment of the present disclosure.

FIG. 10 is a perspective view of a top fitment for a dip tube, according to one embodiment of the present disclosure.

FIG. 11 shows a perspective view of a bottom fitment for a dip tube, according to one embodiment of the present disclosure.

FIG. 12 shows a bottom fitment for a dip tube, according to another embodiment of the present disclosure.

FIG. 13 shows a bottom fitment for a dip tube, according to another embodiment of the present disclosure.

FIG. 14a shows a bottom fitment for a dip tube, according to another embodiment of the present disclosure.

FIG. 14b shows a bottom fitment for a dip tube, according to another embodiment of the present disclosure.

FIG. 15 shows a bottom fitment for a dip tube, according to another embodiment of the present disclosure.

FIG. 16a shows a bottom fitment for a dip tube, according to another embodiment of the present disclosure.

FIG. 16b shows a bottom fitment for a dip tube, according to another embodiment of the present disclosure.

FIG. 17 shows a dip tube for use with a liner, according to another embodiment of the present disclosure.

FIG. 18 shows a bottom fitment for a dip tube, according to another embodiment of the present disclosure.

FIG. 19 shows a bottom fitment for a dip tube, according to another embodiment of the present disclosure.

FIG. 20 shows a bottom fitment for a dip tube, according to another embodiment of the present disclosure.

FIG. 21 shows a liner that may have a dip tube attached, according to one embodiment of the present disclosure.

FIG. 22 shows a liner including a type of mixer, according to one embodiment of the present disclosure.

FIG. 23 shows a liner including a sparger according to one embodiment of the present disclosure.

FIG. 24 shows a liner including a mixer and a sparger according to one embodiment of the present disclosure.

FIG. 25 shows a liner including another type of mixer according to another embodiment of the present disclosure..

FIG. 26 shows an alternate embodiment of the mixer of FIG. 25.

FIG. 27 shows yet another embodiment of a mixer according to another embodiment of the present disclosure.

FIG. 28 shows a mixer positioned external to the liner according to one embodiment of the present disclosure.

FIG. 28a is the mixer of FIG. 28 in an alternate position.

FIG. 29 shows another embodiment of a mixer positioned external to the liner according to one embodiment of the present disclosure.

FIG. 29a shows the mixer of FIG. 29 in an alternate position.

### DETAILED DESCRIPTION

The present disclosure relates to novel and advantageous shipping and dispensing systems. More particularly, the present disclosure relates to novel and advantageous disposable liner-based systems for use, in some embodiments, with materials that must maintain their purity, or some high level of purity during shipping and/or dispense. For example the shipping and dispense system of the present disclosure, in one aspect, may be configured for a single use in industries that use materials that must remain substantially pure, uncontaminated, and/or sterile, such as many materials used in, for example, the biopharmaceutical manufacturing and analytical processes industries. Examples of some of the types of materials that may be used with embodiments of the present disclosure include, but are not limited to, reagents, buffers, cell culture media, or other sterile media. Applications may include, but are not limited to, sterile media transfer, vaccine manufacture, filling and formulation, bioreactors feed and harvest, pharmaceutical process fluid transfer, high containment operations, in-process pooling, and transferring buffers.

The use, creation, and/or storage of some materials that may be used with embodiments of the present disclosure may be subject to various rules, regulations, and/or standards. Accordingly, in some embodiments of the present disclosure, the liner-based system and/or the use of the liner-based system may meet guidelines set by the United States Pharmacopeia (“USP”). Specifically, some embodiments of the present disclosure may be suitable to meet Class VI USP guidelines to ensure biocompatibility with plastics. USP's official Reference Standards are highly characterized specimens of drug substances, excipients, impurities, degradation products, dietary supplements, compendia reagents, and performance calibrators. They are specified for use in conducting official USP-NF tests and assays. USP also provides Reference Standards specified in the Food Chemicals Codex as well as authentic substances, high-quality chemical samples, as a service to analytical, clinical, pharmaceutical, and research laboratories. USP's Reference Standards are used in more than 130 countries around the world. USP Reference Standards that are based directly on official monographs in the USP-NF, whose standards and procedures are enforceable by the U.S. Food and Drug Administration (FDA), are recognized as official standards in the U.S., and their use is effective in demonstrating compliance with statutory requirements.

In other embodiments, the liner and/or connector and/or overpack of the present disclosure may be, or may also be, animal derived component free (“ADCF”). Using ADCF materials may be important, for example, because bovine spongiform encephalopathy (“BSE”) and its potential to affect humans emerged as a serious concern. Accordingly, suppliers of many essential animal-sourced components used in cell culture and fermentation processes, for example, became concerned about the potential for material contamination with prions. Viruses also can be present in raw materials derived from animal origins. Many important drug and vaccine products are made by mammalian cell culture or bacterial fermentation, so their biological safety is paramount. However, it is very difficult to ensure that any material from an animal source carries no infection. Even the rigorous cleaning methods designed to minimize carry-over of biohazards from one batch to the next is no guarantee of safety. Thus the use of ACDF materials for storing, shipping and dispensing biological and/or biopharmaceutical media may be advantageous.

The liner-based systems of the present disclosure may hold up to approximately 200 liters, in some embodiments. Alternatively, the liner-based systems may hold up to approximately 20 liters. Alternatively, the liner-based systems may hold approximately 1 to 5 liters. It will be appreciated that the referenced container sizes are examples only and that the liner-based systems of the present disclosure may be readily adapted for use with a wide variety of sized and shaped shipping and dispensing containers. The entire liner-based system of the present disclosure may be used a single-time and then disposed of in some embodiments. In other embodiments, the overpack, for example, may be reused while the liner and/or the connector may be used only a single time.

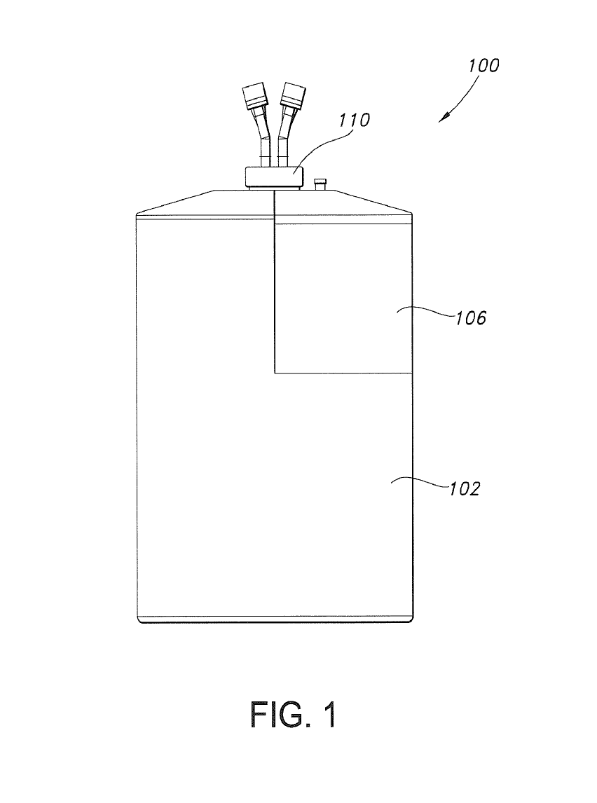

FIG. 1 illustrates a partial cut-away view of one embodiment of a liner-based assembly 100 of the present disclosure. In some embodiments, the liner-based assembly 100 may include an overpack 102, a liner 106, and a connector 110. The liner 106 may comprise a flexible body, such as one comprises of one or more pieces of film bonded together to form an interior compartment, which body then takes the shape of whatever substance is contained within the interior compartment, but may also comprise a semi-rigid body that is capable of self-support. The semi-rigid body may be formed by molding techniques, and may thus be made seamless.

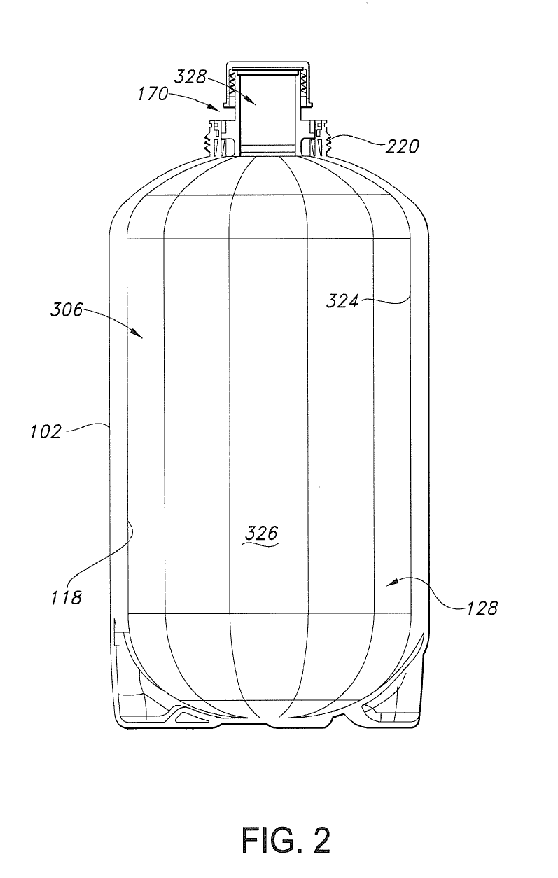

As may be seen in FIG. 2, the overpack 102 may include an overpack wall 118, an interior cavity 128, and a mouth 170. The outside of the mouth 170 of the overpack 102 may have threads 220 that may couple with complementary threads on a connector 110 (discussed more fully below). It will be appreciated that the mouth 170 of the overpack 102 may alternatively or additionally have any other means for coupling to a connector such as a snap-fit mechanism or any other suitable mechanism or combination of mechanisms for coupling.

The overpack 102 may be comprised of any suitable material or combination of materials, such as, plastic, glass, or metal. For example, the overpack 102 may be comprised of any suitable material or combination of materials, including but not limited to, one or more polymers, including plastics, nylons, EVOH, polyolefins, or other natural or synthetic polymers. In further embodiments, the overpack 102 may be manufactured using polyethylene terephthalate (PET), polyethylene naphthalate (PEN), poly(butylene 2,6-naphthalate) (PBN), polyethylene (PE), linear low-density polyethylene (LLDPE), low-density polyethylene (LDPE), medium-density polyethylene (MDPE), high-density polyethylene (HDPE), polypropylene (PP), and/or a fluoropolymer, such as but not limited to, polychlorotrifluoroethylene (PCTFE), polytetrafluoroethylene (PTFE), fluorinated ethylene propylene (FEP), and perfluoroalkoxy (PFA).

The overpack 102 may be of any suitable shape or configuration, such as, but not limited to, a bottle, a can, a drum, etc. For instance, by way of example and not limitation, in one embodiment the overpack 102 may be a carboy. In another embodiment, the overpack 102 may be what is typically referred to as a metal can. The overpack 102 may be manufactured using any process, such as injection blow molding, injection stretch blow molding, extrusion, etc. The overpack 102 may be manufactured as a single component or may be a combination of multiple components.

In some embodiments, the overpack 102 may have a relatively simplistic design with a generally smooth overpack wall 118 and interior cavity 128. In other embodiments, the overpack 102 may have a relatively complicated design including, for example and not limited to, indentations, protrusions, and/or varying wall 118 thickness. Such a container may be substantially similar to the overpack containers disclosed in International PCT Appl. No. PCT/US10/51786, titled “Material Storage and Dispensing System and Method With Degassing Assembly,” filed Oct. 7, 2010; International PCT Patent Application No. PCT/US10/41629, titled “Substantially Rigid Collapsible Liner and Flexible Gusseted or Non-Gusseted Liners and Methods of Manufacturing the Same and Methods for Limiting Choke-Off in Liners,” filed on Jul. 9, 2010; International PCT Patent Application No. PCT/US2011/055558, titled “Substantially Rigid Collapsible Liner, Container and/or Liner for Replacing Glass Bottles, and Enhanced Flexible Liners,” filed on Oct. 10, 2011; International PCT Appl. No. PCT/US2011/064141, titled “Generally Cylindrically-Shaped Liner for Use in Pressure Dispense Systems and Methods of Manufacturing the Same,” filed Dec. 9, 2011; U.S. Prov. Appl. No. 61/468,832, titled “Liner-Based Dispenser,” filed Mar. 29, 2011; U.S. Prov. Appl. No. 61/525,540, titled “Liner-Based Dispensing Systems,” filed August 19, 2011; U.S. Prov. Appl. No. 61/605,011, titled “Liner-Based Shipping and Dispensing Systems,” filed Feb. 29, 2012; U.S. patent application Ser. No. 11/915,996, titled “Fluid Storage and Dispensing Systems and Processes,” filed Jun. 5, 2006; International PCT Appl. No. PCT/US2011/055560, titled “Nested Blow Molded Liner and Overpack and Methods of Making Same,” filed Oct. 10, 2011; U.S. Pat. No. 7,335,721; U.S. patent application Ser. No. 11/912,629; U.S. patent application Ser. No. 12/302,287; and International PCT Appl. No. PCT/US08/85264, each of which is hereby incorporated by reference herein in its entirety. The overpack 102 for use with the liner-based system 100 of the present disclosure may include any of the embodiments, features, and/or enhancements disclosed in any of the above noted applications, including, but not limited to those associated with, flexible, rigid collapsible, 2-dimensional, 3-dimensional, welded, molded, gusseted, and/or non-gusseted liners, and/or liners that contain folds and/or liners that comprise methods for limiting or eliminating choke-off and liners sold under the brand name NOWPAK by ATMI, Inc. for example.

With reference back to FIG. 1, the liner-based system 100 may also include a liner 106 that may be disposed within the overpack 102. As may be seen in FIG. 2, the liner 306 may include a liner wall 324, an interior cavity 326, and a mouth 328. The liner 306, in one embodiment, may be dimensioned and shaped to substantially conform to the interior of the container or overpack 102. As such, the liner 306 may have a relatively simplistic design with a generally smooth outer surface, or the liner 306 may have a relatively complicated design including, for example but not limited to, indentations and/or protrusions.

In some embodiments, the liner wall 324 may include a generally textured surface in order to minimize leaching and/or adhesion. For example, in some embodiments, the surface may include a plurality of bumps, scales, or projections, which may each have any appropriate size, for example, but not limited to, from about 0.5-100 μm. Texturizing features may be spaced any suitable distance from one another. In some embodiments, the texturizing may comprise a framework, such as a lattice or scaffold, for example. Examples of some suitable texturizing features are described in greater detail in U.S. Pat. No. 6,720,469, U.S. Pat. No. 6,520,997, and U.S. Patent Application Publication No. 2008/0275546, the disclosures of which are all hereby incorporated by reference herein in their entirety. The liner 306 may have a relatively thin liner wall 324, as compared to the thickness of the overpack wall 118. In one embodiment, the liner 306 may be flexible such that the liner wall 324 may be readily collapsed, such as by vacuum through the mouth 328 or by pressure between the liner wall 324 and overpack wall 312, referred to herein as the annular space 340.

The liner 306, in a further embodiment, may have a shape, when inflated or filled, that is different from, but complimentary with, the shape of the overpack 102 such that it may be disposed therein. In some embodiments, the liner 306 may be removably attached to the interior of the overpack wall 118. The liner 306 may provide a barrier, such as a gas barrier, against drive gas migration from the space between the liner wall and the overpack wall 118. Accordingly, the liner may generally ensure and/or maintain the purity of the contents within the liner.

In some embodiments, the liner 306 may be manufactured using one or more polymers, including plastics, nylons, EVOH, polyolefins, or other natural or synthetic polymers. In a further embodiment, the liner 306 may be manufactured using polyethylene terephthalate (PET), polyethylene naphthalate (PEN), poly(butylene 2,6-naphthalate) (PBN), polyethylene (PE), linear low-density polyethylene (LLDPE), low-density polyethylene (LDPE), medium-density polyethylene (MDPE), high-density polyethylene (HDPE), polypropylene (PP), and/or a fluoropolymer, such as but not limited to, polychlorotrifluoroethylene (PCTFE), polytetrafluoroethylene (PTFE), fluorinated ethylene propylene (FEP), and perfluoroalkoxy (PFA).

In some embodiments, particularly where sterility of the contents of the liner must be substantially maintained, the liner 306 may be comprised of a material that may help ensure or maintain a sterile environment for the contents disposed in the liner. For example, in some embodiments the liner may be comprised of TK8 manufactured by ATMI, Inc. of Danbury, Conn., or any other suitable material. In some embodiments, the liner 306 may comprise multiple layers. The multiple layers may comprise one or more different polymers or other suitable materials. In some embodiments, the thickness, ply, and/or the composition of the liner and/or the layers of the liner may allow for the secure and substantially uncontaminated shipment of the contents of the liner-based system of the present disclosure by limiting or eliminating typical weaknesses or problems associated with traditional liners or packages, such as, for example weld tears, pin holes, gas entrainment, and/or any other means of contamination. Similarly, or in addition, the liner disposed in the overpack may also contribute to the secure and substantially uncontaminated shipment of the contents of the liner-based system of the present disclosure by configuring the liner to substantially conform to the shape of the overpack when the liner is filled, thereby reducing the amount of movement of the contents during shipping.

The mouth 328 of the liner 306 may also have a fitment portion 330. The fitment portion 330 may be made of a different material than the rest of the liner 306. For example, the fitment portion 330 may be harder, more resilient, and/or less flexible than the rest of the liner 306.

A liner 106, 306 of the present disclosure, in some embodiments, may be substantially similar to the liners disclosed in International PCT Appl. No. PCT/US 10/51786, titled “Material Storage and Dispensing System and Method With Degassing Assembly,” filed Oct. 7, 2010; International PCT Patent Application No. PCT/US10/41629, titled “Substantially Rigid Collapsible Liner and Flexible Gusseted or Non-Gusseted Liners and Methods of Manufacturing the Same and Methods for Limiting Choke-Off in Liners,” filed on Jul. 9, 2010; International PCT Patent Application No. PCT/US2011/055558, titled “Substantially Rigid Collapsible Liner, Container and/or Liner for Replacing Glass Bottles, and Enhanced Flexible Liners,” filed on Oct. 10, 2011; International PCT Appl. No. PCT/US2011/064141, titled “Generally Cylindrically-Shaped Liner for Use in Pressure Dispense Systems and Methods of Manufacturing the Same,” filed Dec. 9, 2011; U.S. Prov. Appl. No. 61/468,832, titled “Liner-Based Dispenser,” filed Mar.29, 2011; U.S. Prov. Appl. No. 61/525,540, titled “Liner-Based Dispensing Systems,” filed Aug. 19, 2011; U.S. Prov. Appl. No. 61/605,011, titled “Liner-Based Shipping and Dispensing Systems,” filed Feb. 29, 2012; U.S. patent application Ser. No. 11/915,996, titled “Fluid Storage and Dispensing Systems and Processes,” filed Jun. 5, 2006; International PCT Appl. No. PCT/US2011/055560, titled “Nested Blow Molded Liner and Overpack and Methods of Making Same,” filed Oct. 10, 2011; U.S. Pat. No. 7,335,721; U.S. patent application Ser. No. 11/912,629; U.S. patent application Ser. No. 12/302,287; and International PCT Appl. No. PCT/US08/85264, each of which is hereby incorporated by reference herein in its entirety. The liner 106, 306 for use with the liner-based system 100 of the present disclosure may include any of the embodiments, features, and/or enhancements disclosed in any of the above noted applications, including, but not limited to, flexible, rigid collapsible, 2-dimensional, 3-dimensional, welded, molded, gusseted, and/or non-gusseted liners, and/or liners that contain folds and/or liners that comprise methods for limiting or eliminating choke-off and liners sold under the brand name NOWPAK by ATMI, Inc. for example.

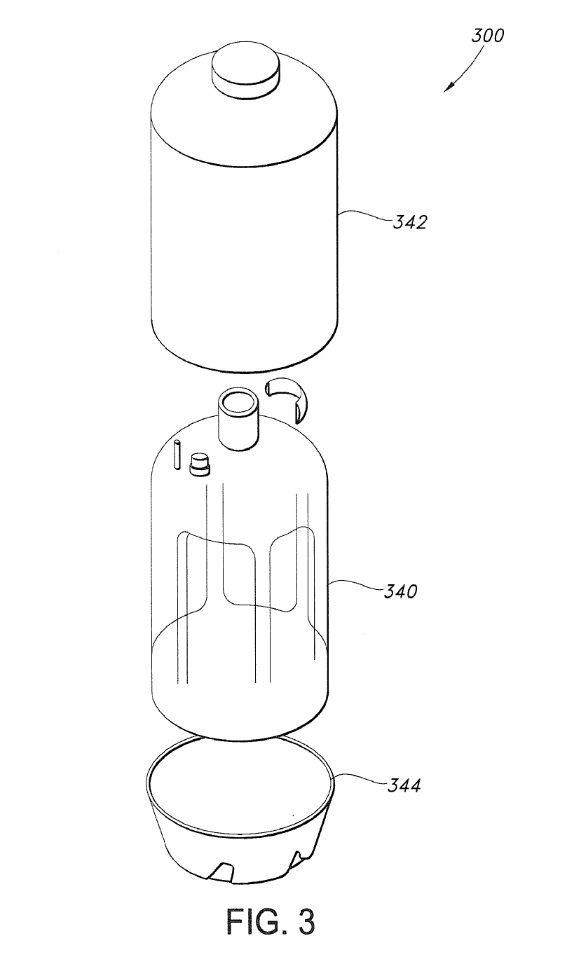

As particularly disclosed, for example, in U.S. Prov. Appl. No. 61/605,011, titled “Liner-Based Shipping and Dispensing Systems,” filed Feb. 29, 2012, in one embodiment, and as illustrated in FIG. 3, a liner-based system may include an overpack comprised of more than a single piece. For example, a liner-based system 300 may include a liner 340 manufactured by any of the means described herein, an overpack top piece 342, and an overpack base cup 344. The overpack top piece 342 and base cup 344 operably couple together to form an overpack for the liner 340. In this regard, the liner 340 may be positioned within the overpack top piece 342, such that a portion of the liner neck may extend through and/or beyond the mouth of the overpack top piece. The overpack top piece 342 with the liner 340 positioned therein may then be positioned onto the base cup 344. In some embodiments, the overpack top piece 342 may couple with the base cup 344, and may couple with the base cup by any suitable means including but not limited to, snap-fit, friction-fit, bayonet connection, adhesives/sealants, welding or any other suitable means of connection or combination thereof. Complementary threading may be used or may also be used to couple the two portions of the overpack.

A connector 110 of the present disclosure in some embodiments may include connecting features, a pressurizing gas inlet, and one or more ports. The connector 110 may be comprised of any suitable material, such as metal, plastic, or any other material or combination of materials. The connector 110 may be formed by any suitable means such as injection molding and/or machining, for instance.

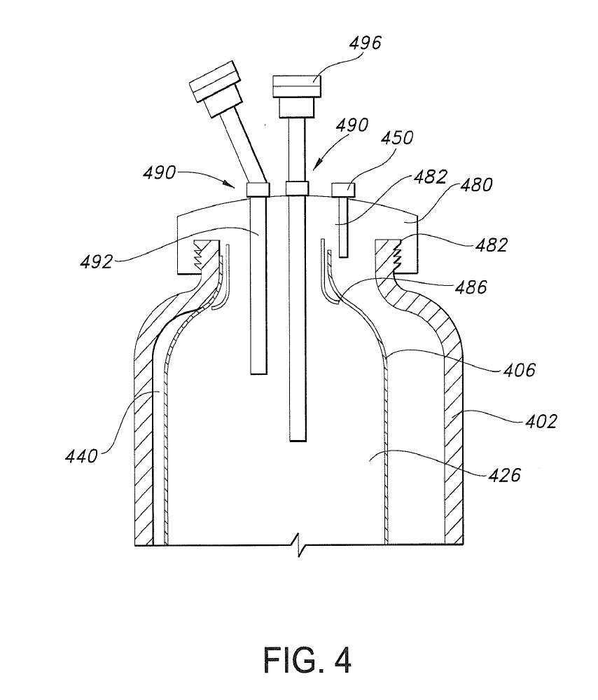

As may be seen in FIG. 4, in some embodiments, connecting features of the connector 480 may include threads 482 that couple to complimentary threads 220 on the mouth 170 (FIG. 2) of the container 402. It will be recognized that any alternative or additional coupling means may be employed to couple the connector 480 to the container 402 of the present disclosure, for example, but not limited to, a snap fit connection, friction fit connection, bayonet connection, etc. The connecting features of the connector 480 may also include a securing apparatus 486 to hold a liner 406 in a suitable position. As may be seen, the securing apparatus 486 in some embodiments may include a holding ring or one or more arms that may be inserted into the interior of the liner that may hold the fitment 430 of the liner 406 in a suitable position for shipping, storage, and/or dispense. It will be understood however, that the connector 480 may secure the liner 406 in any suitable way, such as by snap fit, threading, or any other suitable means or combination of means. The securing apparatus 486, in another embodiment, may comprise a portion of the fitment 430 of the liner 406, and accordingly may be integral with the liner 406. In embodiments of connectors 480 that include a securing apparatus for the liner that extends into the interior 426 of the liner, the securing apparatus may, or may also, be comprised of a material that may be suitable for use in a sterile environment, such as those listed above, or any other suitable material, or combination of materials.

The connector 480 may also include a pressurizing gas inlet 450. The pressurizing gas inlet 450 may include a tube opening 452 that generally permits a gas pressure in-line (described more fully below) to be inserted through the connector 480 and in fluid communication with the annular space 440 between the liner 406 and the overpack 402, such that a fluid, gas, or other suitable substance may be introduced into the annular space 440, thereby pushing the contents of the liner out of the liner (discussed more fully below). In embodiments of the present disclosure that use pump-dispense to discharge the contents of the container, the pressurizing gas inlet 450 may function as a vent, and accordingly may not need to be connected to a gas pressure in-line. In other embodiments, a pressurizing gas inlet may not form a part of the connector, but instead may be positioned on the overpack, and in some cases may be integral with the overpack.

The connector 480 may also include one or more ports 490 to permit filling of the liner and/or dispensing of the contents of the liner. The one or more ports 490 may include dip tubes 492 that may extend any suitable distance into the interior of the liner 426. In embodiments of connectors that include more than one port with dip tubes, the dip tubes may extend the same or different distances into the interior of the liner. A dip tube 492 may extend for example ½ the distance into the container, or a dip tube 492 may extend less than or more than ½ the distance into the container. The dip tube may be made of plastic, rubber, glass, or any other suitable material, or combination of materials. In embodiments of the present disclosure where purity of the contents must be substantially maintained, the one or more dip tubes 492 may be comprised of a material that helps ensure and/or maintain a substantially sterile environment inside of the liner, such as the materials listed above, or any other suitable material, or combination of materials.

In other embodiments, for example but not limited to those for use with pressure dispense applications, the one or more dip tubes 492 may extend only a relatively short distance into the liner, which in some cases may be referred to as a “stubby probe.” Examples of “stubby probes” that may be used with the present disclosure may be those of ATMI, Inc. of Danbury, Conn., or those disclosed in PCT Application No. PCT/US07/70911, entitled “Liquid Dispensing Systems Encompassing Gas,” with an international filing date of Jun. 11, 2007, which is hereby incorporated by reference herein in its entirety.

In some embodiments, distal ends of the one or more ports may be integrally or detachably attached to quick connect connectors 496, for example. Generally, a quick connect connector 496 may allow for the dry connection of two separate fluid pathways, while maintaining the sterile integrity of both. Typically, a connection may include a male and a female connector, each of which may be covered by a vented peel away strip that protects the port and maintains the sterility of the sterile fluid pathway. Connector 496 may be either of the male or female variety. Accordingly, quick connects may allow for the sterile transfer of fluid from one source to another, in some cases without the need for a clean room. Such quick connects are generally known and may be used with embodiments of the present disclosure, including, but not limited to quick connects from Colder Products Company and/or Saint-Gobain, for example. In other embodiments, one or more ports 490 may have connecting features for securely and substantially aseptically attaching to a quick connect connector.

The liner-based system may also include features for helping prevent or limit choke-off. Generally speaking, choke-off may be described as what occurs when a liner ultimately collapses on itself, or a structure internal to the liner, to form a choke point disposed above a substantial amount of liquid. When choke-off occurs, it may preclude complete utilization of the liquid disposed within the liner, which can be a significant problem, as many materials used in the biotechnology and/or pharmaceutical industry, for example, can be very expensive. A variety of ways of preventing or handling choke-off are described in PCT Application Number PCT/US08/52506, entitled, “Prevention Of Liner Choke-off In Liner-based Pressure Dispensation System,” with an international filing date of Jan. 30, 2008, which is hereby incorporated herein by reference in its entirety. Additional ways of preventing or handling choke-off are described in International PCT Patent Application No. PCT/US10/41629, titled “Substantially Rigid Collapsible Liner and Flexible Gusseted or Non-Gusseted Liners and Methods of Manufacturing the Same and Methods for Limiting Choke-Off in Liners,” filed on Jul. 9, 2010, and International PCT Patent Application No. PCT/US2011/055558, titled “Substantially Rigid Collapsible Liner, Container and/or Liner for Replacing Glass Bottles, and Enhanced Flexible Liners,” filed on Oct. 10, 2011, which were previously incorporated herein by reference in their entirety.

In use, in some embodiments, a liner-based system may arrive at a first filling site, for example, with the system fully assembled including an overpack, liner and connector. In some cases, the liner and/or the connector may be irradiated and sterilized at a manufacturing site, such that that the sterilization process may not need to be performed at the filling site. As part of the sterilization process, the liner may be evacuated and may include substantially no gases and be ready for filling upon arrival, for example, at the fill site. In other embodiments. The liner and/or connector may be irradiated and/or sterilized at the fill site prior to filling.

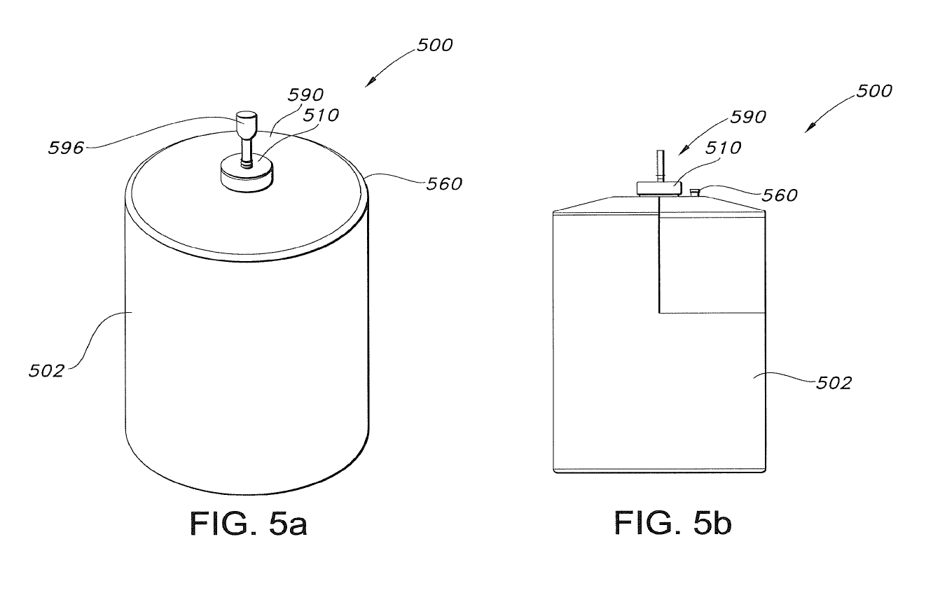

With reference to FIGS. 5A and 5B, in some embodiments a connector 510 may include one port 590 that may serve as both a fill port and a dispense port, as described herein. In use, such an embodiment may have a sterile and evacuated liner positioned in an overpack 502. A connector 510 may be secured to the system 500 and may include one port 590 that may serve as both a fill port and a dispense port. As discussed above, in some embodiments the system may come from the manufacturer so assembled and already sterilized. In other embodiments, the liner may be sterilized and positioned in the overpack, and/or the connector may be sterilized and connected to the overpack and/or liner at the fill site. In some embodiments, a quick connect 596 may also be coupled to the port 590, as shown in FIG. 5A, and may be sterilized prior to arrival at a first fill site, for example.

At the fill site, the quick connect 596 may be used to aseptically connect to a fill source in order to fill the contents of the liner. After the fill is complete, in some embodiments, any headspace may be removed from the liner. Headspace generally refers to any gas space in a liner, for example, that may exist above the material stored in the liner. Headspace may be undesirable because it may allow for some of the headspace gas to enter the material, thereby contaminating the material. Limiting or eliminating headspace may be particularly important for systems that may be transported. The movement of the material in the liner that may occur when headspace is present may cause foaming, bubbling, stress, protein damage, and/or gas contamination of the material, for example, which can be highly undesirable wherein maintaining the purity of the contents of the system is crucial. The headspace may be removed by connecting a pressure source to the pressurizing gas inlet 560 and introducing a suitable gas or fluid into the annular space between the liner and the overpack. The increased pressure in the annular space may push the liner in upon itself, thereby forcing out any excess gas in the liner.

Once the liner has been filled, and in some embodiments, the headspace has been substantially removed, the tubing below the quick connect 596 may be aseptically sealed off and the quick connect 596 may thus be removed, as may be seen in FIG. 5B. In some cases, the system 500 may then be shipped to a second site. While in other cases, the filled system may be stored at the first site prior to dispense at a subsequent time at the first site.

Prior to dispense, a sterile tube fuser, for example, may be used to connect tubing between the system 500 and a dispense receptacle. Sterile tube fusers are known automated devices for welding together dry or fluid-filled thermoplastic tubing in a sterile operation without the need for a laminar flow cabinet or a similar environmental control device. Any suitable sterile tube fuser may be used with embodiments of the present disclosure, for example, but not limited to the Wave Sterile Tube Fuser by GE Healthcare. Once the sterile tubing connection has been made between the system and the dispense receptacle, dispense may occur (discussed further below). Dispense may be by pressure dispense, pump dispense, pressure-assisted pump dispense, or gravitational dispense, for example. After dispense, the connector and/or the liner may be disposed of, and in some cases the overpack may be cleaned, sterilized and reused. In other embodiments, the overpack may also be disposed after a single use.

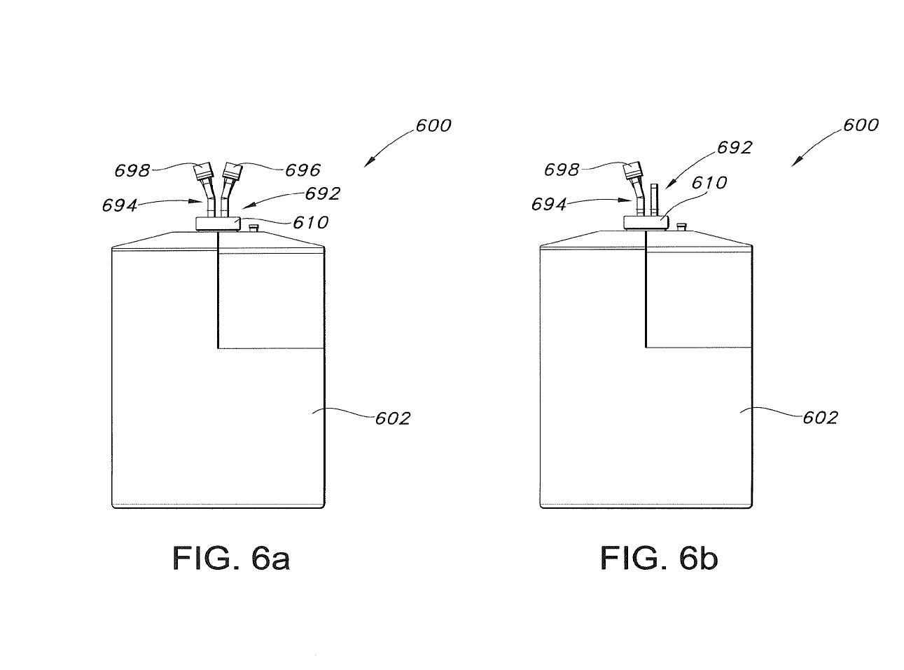

In another embodiment, as shown in FIGS. 6a and 6b, the system 600 may include a connector 610 with multiple ports. As may be seen, in some embodiments the connector 610 may include two ports, 692, 694. It will be understood, however, that the connector 610 of the present disclosure may be adapted to include any number of useful ports. In such an embodiment, one port may be used as a fill port 692, and another port may be used as a dispense port 694. Similar to the one port embodiment described above, in use, such an embodiment may have a sterile and evacuated liner positioned in an overpack 602 with a sterile connector 610 secured thereto.

As discussed above, in some embodiments the system may come from the manufacturer so assembled and already sterilized. In other embodiments, the liner may be sterilized and positioned in the overpack, and/or the connector may be sterilized and connected to the overpack and/or liner at the fill site. In some embodiments, a quick connect 696 may be coupled to the fill port 692, and another quick connect 698 may be coupled to the dispense port 694, as shown in FIG. 6a. At the fill site, the quick connect 696 coupled to the fill port 692 may be operably connected to a fill source in order to aseptically fill the contents of the liner. As was described above with regard to the one port connector embodiment, in some embodiments, any headspace may be removed from the liner by connecting a pressure source to the pressurizing gas inlet 560 and introducing a suitable gas or fluid into the annular space between the liner and the overpack. The increased pressure in the annular space may push the liner in upon itself, thereby forcing out any excess gas in the liner.

After the fill is complete, and in some embodiments, after headspace removal, the tubing below the quick connect 696 that is coupled to the fill port 692 may be aseptically sealed off and the quick connect coupled to the fill port 692, may be thus removed, as may be seen in FIG. 6B. In some cases, the system 600 may then be shipped to a second site, while in other cases, the filled system may be stored at the first site prior to dispense at a subsequent time at the first site.

Prior to dispense, the quick connect 698 of the dispense port 694 may be operably coupled to the tubing of a dispense assembly. Once the sterile tubing connection has been made between the system and the dispense receptacle, dispense may occur (discussed further below). Dispense may be by pressure dispense, pump dispense, pressure-assisted pump dispense, or gravitational dispense. After dispense, the connector and/or the liner may be disposed of, and in some cases the overpack may be cleaned, sterilized and reused. In other embodiments, the overpack may also be dispose of after a single use.

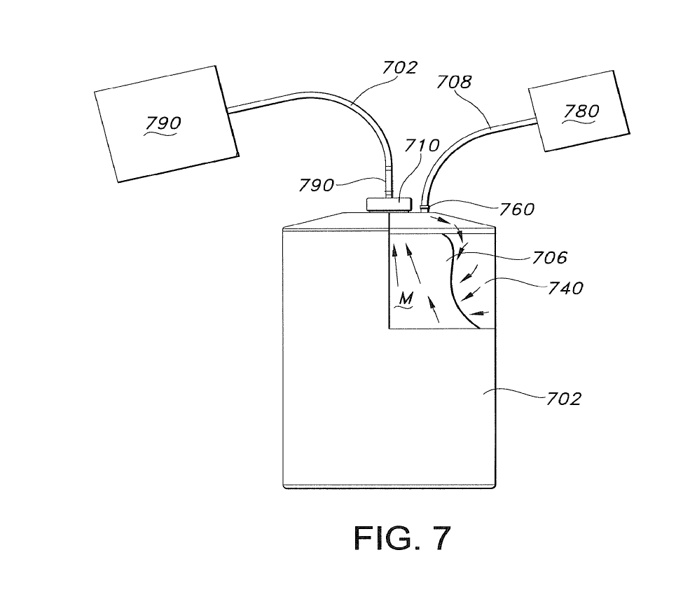

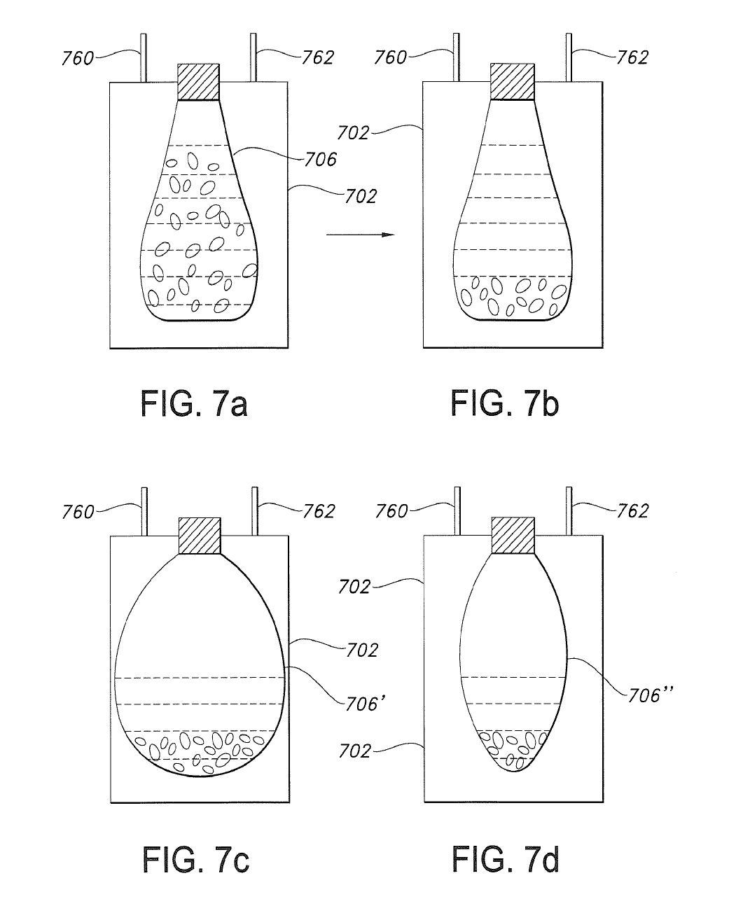

FIG. 7 generally shows how the system of the present disclosure may operate during liquid dispense, specifically pressure dispense, according to one embodiment. One end of a gas pressure in-line 708 may be connected to the pressurizing gas inlet fitting 760 while the other end may be connected to a pressurized gas or fluid source 780. The port 790 on the connector 710 used for dispense may be operably coupled to a user's end system 790, for example. In one embodiment, the gas or fluid source 780 may be regulated to push pressurized gas or fluid into the area between the annular space 740 between the inside wall of the container 702 and the outside wall of the liner 706. As can be seen, as the amount of gas or fluid increases in the space between the wall of the container 702 and the wall of the liner 706, the flexible liner 706 will begin to collapse in upon itself, which will force the contents M of the liner 706 up through the dispense port 790 of the connector 710 and into the dispensing receptacle 790. Gas or fluid may continue to be added until substantially all of the contents M of the liner 706 have been dispensed from the liner. Once liquid dispense has been completed and/or the liner 706 has been substantially emptied, the gas pressure in-line 708 may be removed from the pressurizing gas inlet 760, which in some embodiments may also release the pressure gas in the annular space 740. As discussed above, in some embodiments, the liner and/or the connector may be removed and disposed of, while in some embodiments the overpack may be cleaned, sterilized, and reused. In some embodiments the overpack may be disposed of after a single use.

In some embodiments, the controlled and varied introduction of pressurized gas or liquid into the annular space 740 may be used to mix the contents of the liner when partially filed, including prior to being dispensed, in order to maximize homogeneity. For example, the contents of the liner 706 may settle over time, and possible separate into different fractions (compare FIGS. 7a and 7b). As should be appreciated, dispensing the contents without further efforts at homogenization would potentially lead to an undesirable output.

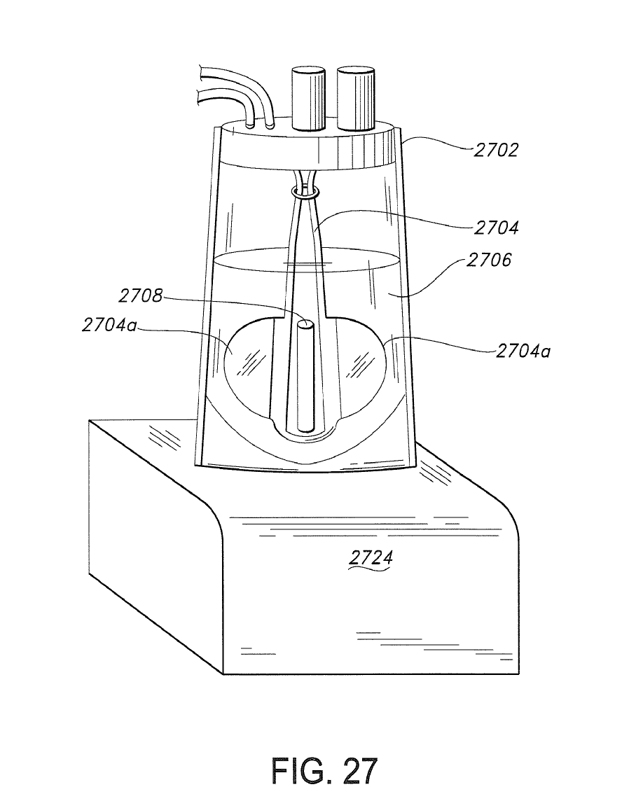

To account for this, a controlled cycle of pressurization and depressurization resulting in compression and relaxation of the liner may cause the contents of the partially filed liner to mix. Thus, as illustrated, a fluid (gas or liquid) may be supplied to the pressurizing inlet 760, such as from a fluid source 780, and exhausted through an outlet 762, while the dispense port remains sealed. This may cause the relaxation of the liner 706′ (FIG. 7c) and pressurization of the liner 706″ (FIG. 7d) and thus allow for the sterile mixing of the contents without the need for impellers or paddles. In one embodiment, the liner 706 is filled with the substance less than about 70% (with about 30% headspace) in order to provide suitable mixing based on the external pressurization of the space, and without dispensing until the desired level of mixing is achieved. Alternatively, as outlined further in the description that follows, the mixing may be achieved by an element connected to or adjacent the liner, such as an agitator (see, e.g., FIGS. 27-31).

The use of pressure dispense may be advantageous over methods currently used in relevant industries, such as dispense by peristaltic pumps. The use of pumps to dispense the contents of a liner may cause bubbling and stress on the material and the system, which may be undesirable because the purity of the contents of the liner may be crucial. The use of pressure dispense may help avoid or eliminate these problems. Further, in some cases a higher rate of dispense may be achieved by pressure dispense as opposed to pump dispense.

Nonetheless, in some embodiments of the present disclosure, pump dispense may be used. In such embodiments, a pressure source may not be coupled to the pressurizing gas inlet 760. Instead, the inlet 760 may be opened to the air and serve as a vent, for example, during a pump-dispense application. In such an embodiment, the contents M of the liner 706 may be pumped out of the liner 706 through the dispense port 790. The liner may collapse in as liquid is dispensed out of the container.

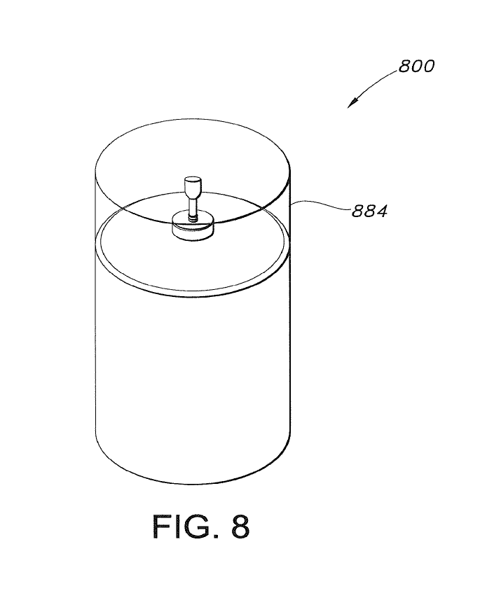

In some embodiments, the system of the present disclosure may include a shipping ring 884, as shown in FIG. 8. The shipping ring 884 may be placed over the connector to protect the assembly from damage and/or leaks during shipping and/or storage. The shipping ring 884 may extend above the connector and may be comprised of metal, plastic, or any other suitable material, or combination of materials. In some embodiments, the system 800 may also be placed in a standard clean-room bag and/or placed in a suitable shipping box. The shipping box may then be sealed prior to shipping.

In another embodiment, the liner may first be filled with a solid material, for example, but not limited to, a peptide, API, etc. The solid may take up relatively little space within the liner. The liner-based system may then be stored, or in other cases shipped to another site, whereupon the liner may be filled with a sterile liquid. In order to dissolve the solid in the liquid, the liner may be shaken or otherwise moved. The contents of the liner may then be dispensed or shipped to another location for dispense. In use, such an embodiment may be substantially similar to the embodiments described above, including systems comprising connectors that have one or more ports, as described above. Using such an embodiment would allow a user to avoid having to transfer the solid material to a new container for sterile mixing, thereby minimizing the risk of contamination and saving time, labor, and any associated costs, for example.

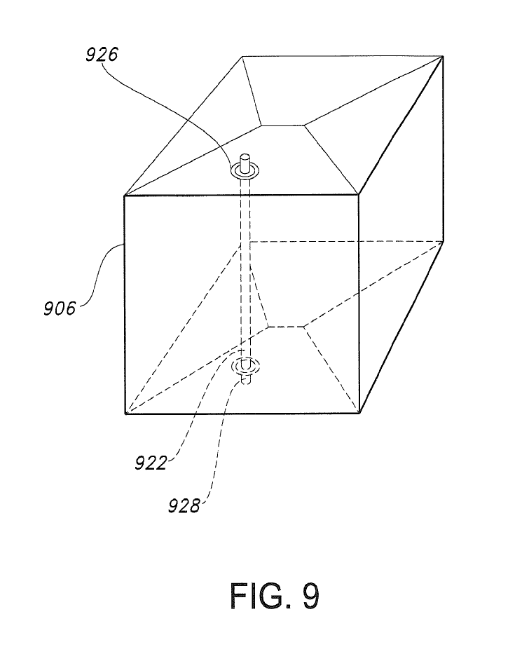

As discussed above, in some embodiments a dip tube may be inserted some distance into the liner. In some embodiments, as may be seen in FIG. 9, a dip tube 922 may span substantially the entire length of a liner. In such embodiments, the dip tube 922 may attach to the liner 906 at both the top and also at the bottom. Anchoring the dip tube at the bottom of the liner may help minimize splashing or other disruption of the chemical or material being introduced into the liner via the dip tube. Minimizing the amount of splashing/disruption etc. may advantageously help keep bubbles from forming in the contents of the liner.

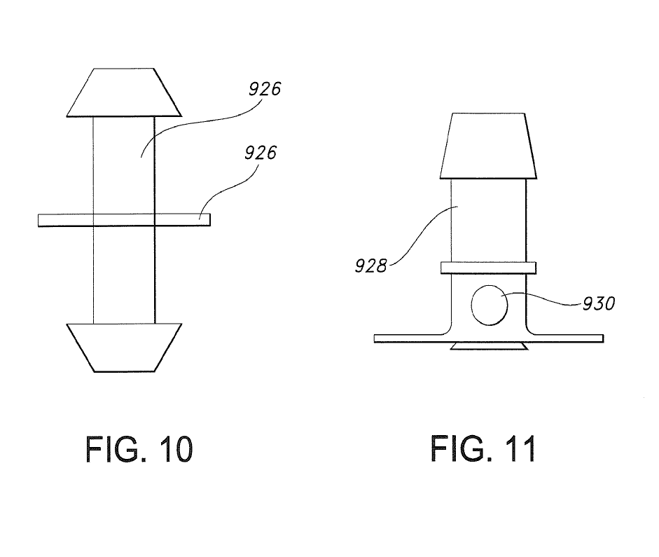

The top and/or bottom fitment 926, 928 may be used to connect with the respective end portions of the dip tube 922. For example, the top fitment 926, as shown in FIGS. 9 and 10, allows the dip tube 922 to pass from the exterior of the liner to the interior of the liner such that materials may be introduced into and/or extracted from the interior of the liner. The bottom fitment 928, as shown in FIG. 11 secures the dip tube 922 to the bottom of the liner so that the dip tube remains in place in the liner and/or fills and/or dispenses properly. The fitments may be formed of a harder plastic or other suitable material than the rest of the liner, in some embodiments. In some embodiments, the top fitment and the bottom fitment may be comprised of the same material, while in other embodiments, they may be comprised of different materials. The dip tube may be made of any suitable material, including plastic, silicon, C-Flex, or any other material or combination of materials.

As may be seen, the bottom fitment 928 may include a through opening 930 that allows a material to either exit the dip tube 922 and enter the interior of the liner 1006 for filling or to enter the dip tube 922 and leave the interior of the liner 906 for dispense. In the embodiment shown in FIGS. 9-10, the dip tube may be generally statically secured to the liner via the bottom fitment, i.e. The bottom fitment generally does not allow for the dip tube to move substantially up or down, or side to side, for example.

In other various embodiments disclosed below, the bottom fitment may allow for ease of movement of the dip tube about its axis and/or up and down and/or side to side. Allowing the dip tube and/or the bottom fitment to move, while still holding the dip tube in place at the bottom of the liner, may lessen the amount of stress that is placed on the liner at the bottom fitment. In some cases, when such liners are shipped empty to the location where the liners will be filled, the liners may be folded for shipment. Folding a liner that has a dip tube that is statically attached to a bottom fitment may cause stress, and in some cases may cause a great deal of stress on the liner at the bottom fitment and/or the top fitment, and/or on the dip tube itself. Therefore, it may be advantageous to allow for some freedom of movement of the dip tube at the bottom fitment.

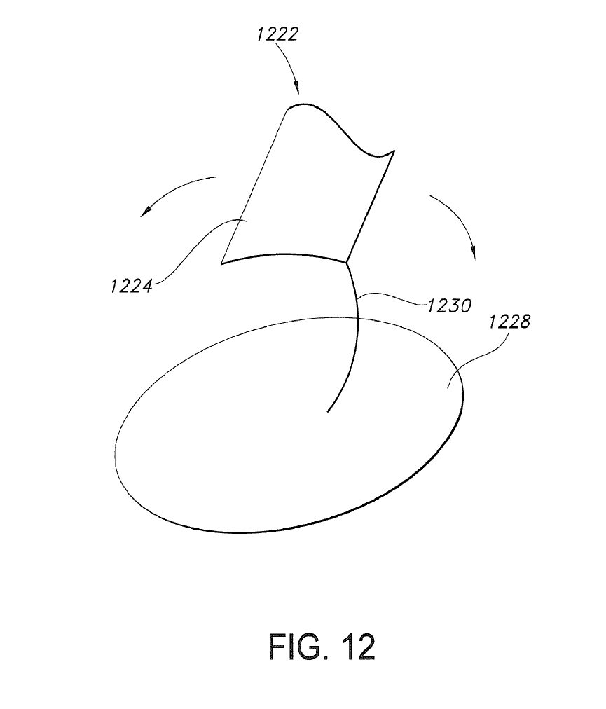

In one embodiment, shown in FIG. 12, the bottom fitment 1228, 1224 may allow the dip tube 1222 to flex by some amount, for example. The lower portion of the bottom fitment 1228 may be secured to the bottom of the interior of the liner. A generally flexible connecting member 1230 may attach to the lower portion of the bottom fitment 1228 and also connect to the upper portion of the fitment 1224. The flexible connecting member 1230 may be a coil, a flexible tube, or any other suitable apparatus that may connect the upper 1224 and lower 1228 portions of the bottom fitment and still allow some degree of bend. By allowing the upper portion 1224 of the fitment to bend, the dip tube 1222 that is affixed to the upper portion 1224 may also have some freedom of movement, thereby generally reducing or alleviating stress on the bottom fitment 1224, 1228 and the liner at the bottom fitment that may otherwise be caused by the dip tube moving.

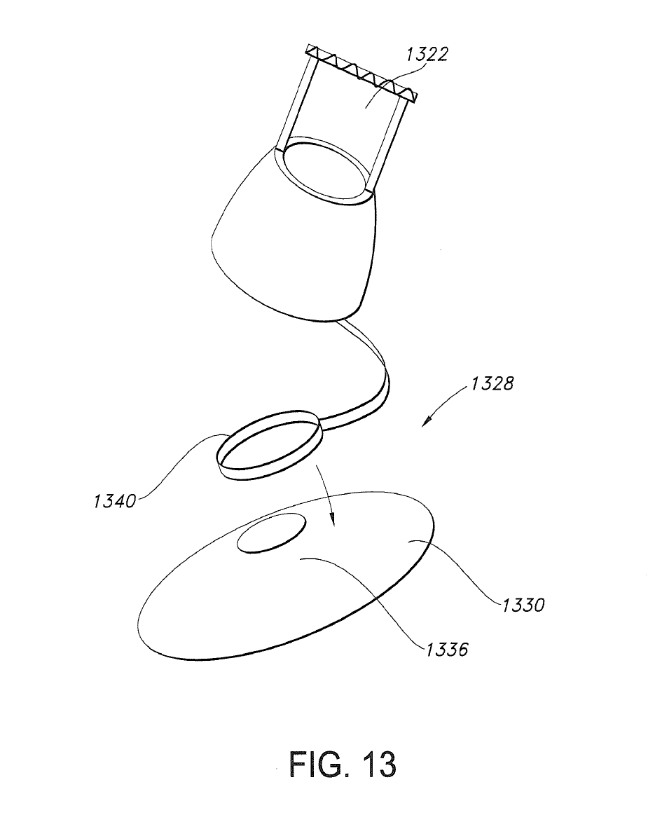

In yet another embodiment, as shown in FIG. 13, a dip tube 1322 may associated with a bottom fitment 1328 configured to not only flex as in the embodiment shown in FIG. 12, but to turn about its axis as well. As may be seen, a lower portion 1330 of the fitment may be welded on the bottom interior surface of the liner. The lower portion 1330 may include an attachment means that allows the upper portion 1340 to connect to the lower portion 1330 in a manner that allows the upper portion 1340 to rotate about the lower portion 1330. For example, the lower portion 1330 may have a raised area that includes a recess or channel 1336, for example, that may couple with a corresponding feature of the upper portion 1340. In other embodiments, the upper portion 1340 may rotatably connect to the lower portion 1330 by any suitable means, such as by snap fit, or any other suitable method.

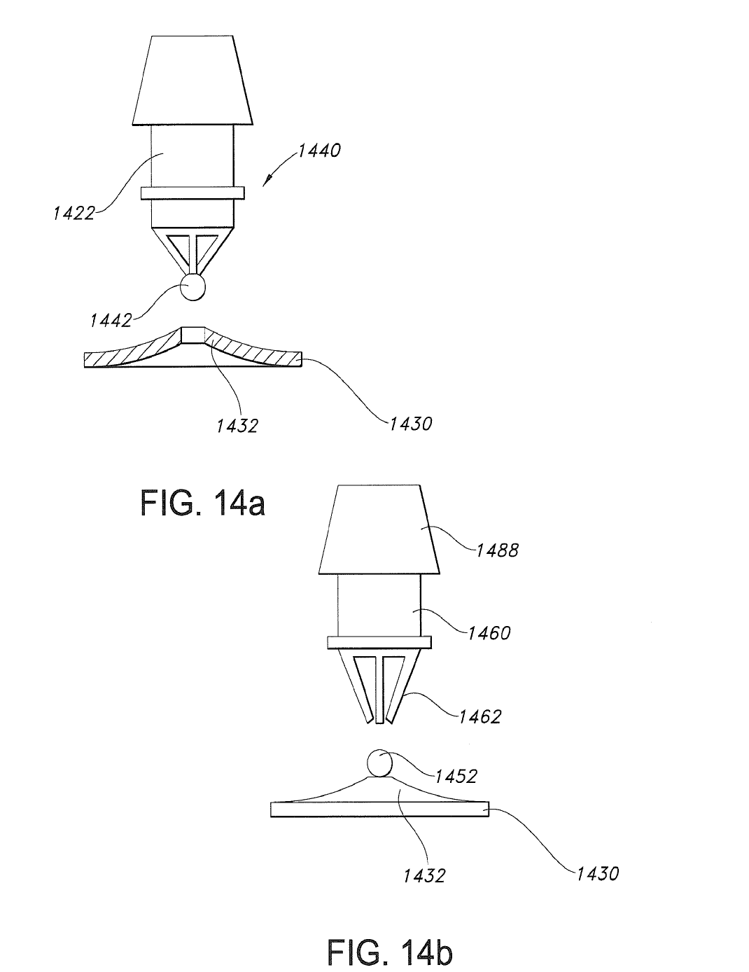

In another embodiment, the bottom fitment may include a ball and socket style connection that may allow the dip tube to swivel and/or rotate about the bottom fitment. Two examples of such an embodiment are shown in FIGS. 14A and 14B. As may be seen in FIG. 14A, a lower portion 1430 of the bottom fitment may include a socket 1432 that may detachably receive a ball 1442 that may be a part of an upper portion 1440 of the fitment. As may be seen, a dip tube 1422 may attach to the upper portion 1440. The dip tube 1422 may attach by any suitable means. In some embodiments, the dip tube may secure to the upper portion 1440 by snap fit, by threadably engaging with the upper portion 1440, or by any other suitable means, or combination of means. As may be seen, because the upper portion 1440 may freely swivel and/or rotate about the lower portion 1430 of the fitment, and because the dip tube 1422 may be attached to the upper portion 1440, the dip tube 1422 may also generally freely swivel and/or rotate within the range of the ball and socket style connection. In another embodiment shown in FIG. 14B, the lower portion 1450 of a bottom fitment may include a ball 1452. An upper portion 1460 of the fitment may include a socket style gripping feature 1462, for example, that may detachably fit onto the ball 1452 of the lower portion 1450. As with the previous embodiment, such a configuration may allow for the upper portion 1460 that may be attached to a dip tube 1488 to freely swivel and/or rotate within the range of the ball and socket style connection.

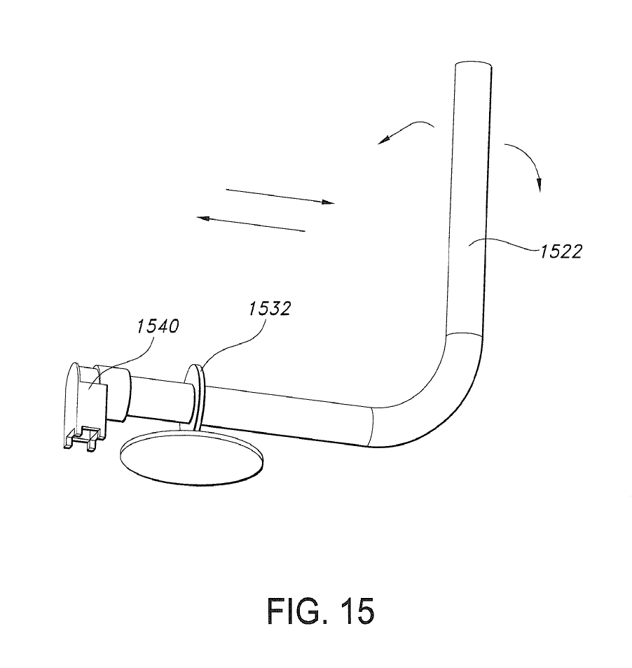

In another embodiment, shown in FIG. 15, a lower portion 1530 of the bottom fitment may attach to the bottom of a liner. The lower portion 1530 may include a ring 1532 that the dip tube 1522 may pass through, which may allow the dip tube to swivel or rotate inside of the ring 1532 and/or move forward and backward within the ring 1532, thereby relieving stress on the liner at the fitment. In such an embodiment, the bottom fitment may also include an upper portion 1540 that may be connected to the end of the dip tube 1522 that may act as a stopper keeping the dip tube 1522 secured within the ring 1532. The upper portion 1540 (as is generally the case with embodiments of bottom fitments described in this section) has an opening that allows a material to move from the dip tube 1522 into the interior of the liner (during filling and/or mixing) and/or to pass into the dip tube 1522 from the interior of the liner (during dispense).

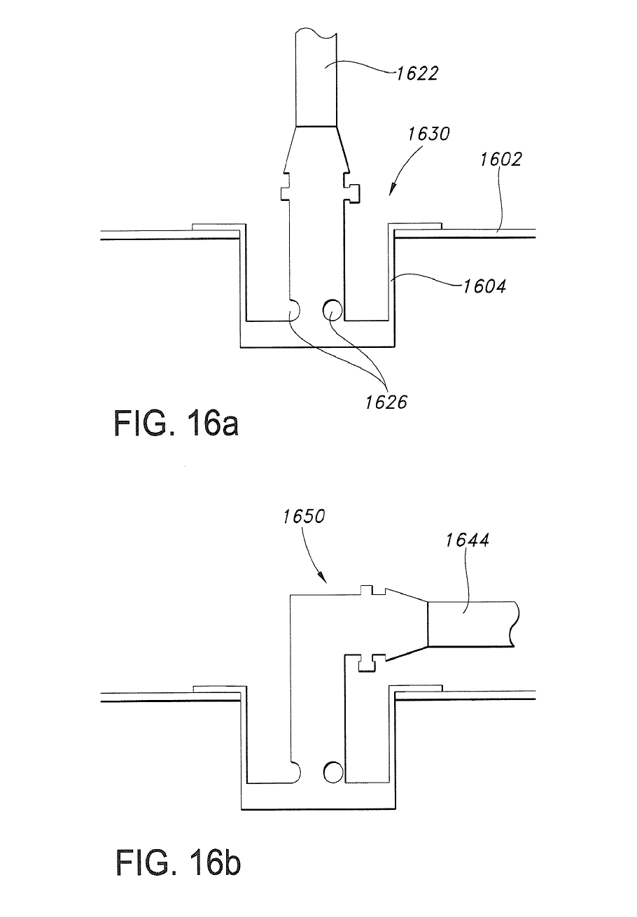

In another embodiment shown in FIG. 16A, the bottom fitment 1630 may be positioned in a sump area 1604. In some embodiments the sump area 1604 may be a part of the bottom fitment that comprises a molded area that may be comprised of a different material than that of the liner 1602. For example, the molded sump area 1604 may be comprised of a harder or more rigid plastic than the liner 1602 or the molded sump area 1604 may be comprised of any suitable material or combination of materials. During dispense the material in the liner may naturally flow to the lowest point in the liner due to gravity. Because the bottom fitment including the opening(s) 1626 is located in the sump area 1604, liners of this embodiment may allow for a greater degree of dispense as the contents of the liner may continue to flow to this area. In another embodiment, as shown in FIG. 16B, the bottom fitment may be bent at an angle, for example a 90 degree angle. In other embodiments, the fitment may bend any suitable or useful degree in order to properly align with the dip tube 1644 and the top fitment. In addition, any other fitment described herein may be used in conjunction with a sump area.

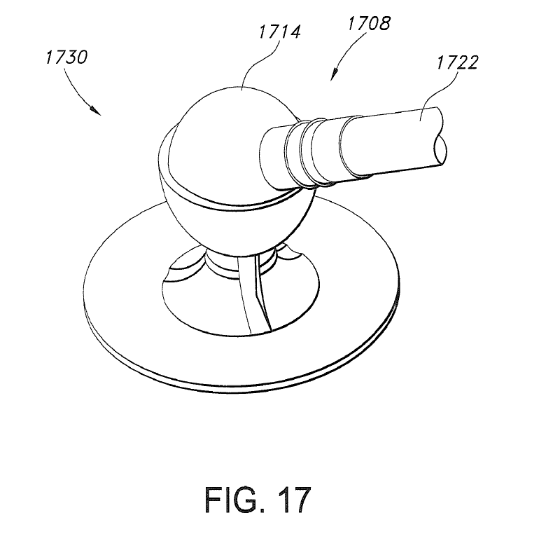

FIG. 17 shows another ball and socket style fitment embodiment where the bottom fitment 1730 may be configured to swivel and/or rotate. The bottom fitment may include a lower portion 1718 that may be secured to the bottom interior of a liner. The lower portion 1718 may also include a socket or cradle 1712 for receiving a ball 1716 from the upper portion 1708. The ball 1716 may be attached to the cradle 1712 of the lower portion by any suitable means such as snap fit, or any other connection mechanism that permits the ball 1716 to rotate within the cradle 1712. The upper portion 1708 may attach to a dip tube 1722 by any suitable means. Because the upper portion 1708 may freely swivel and/or rotate about the lower portion 1718 of the bottom fitment, and because the dip tube 1722 may be attached to the upper portion 1708, the dip tube may freely rotate about the axis of the bottom fitment 1730.

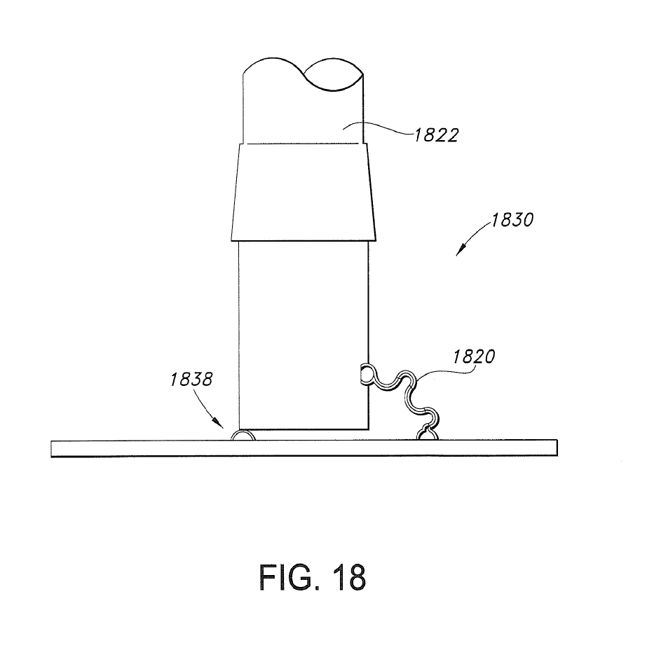

In still another embodiment shown in FIG. 18, the bottom fitment 1830 may include a hinge 1838 that may allow the fitment 1830 to pivot about the hinge 1838. In some embodiments, the bottom fitment 1830 may also include a flexible cable tie 1820, for example, in order to limit or control the hinge action of the hinge 1838. As with other embodiments described herein, the dip tube 1822 may be connected to the bottom fitment 1830, such that the dip tube 1822 may have a degree of movement within the liner.

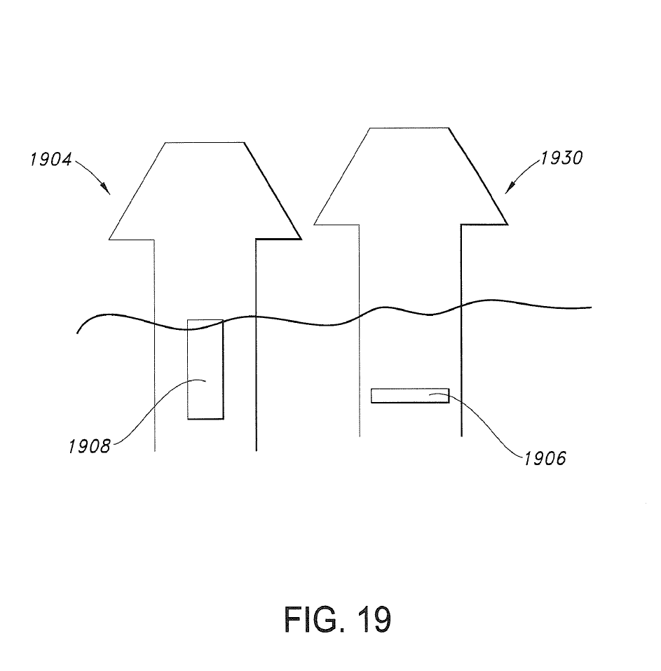

In the embodiments described above, each of the bottom fitments may include an opening, such that material may pass from the dip tube into the liner and vice versa. In one embodiment shown in FIG. 19, an opening 1908 in a bottom fitment 1940 may generally be positioned vertically. In another embodiment, however, as shown in FIG. 19, the opening 1906 may be generally horizontally positioned. While FIGS. 19A and 19B show a generally rectangular opening positioned substantially vertically and horizontally, respectively, any suitable geometry may be used. In some embodiments, for example, the opening may be generally circular, oval, octagonal, or any other geometry. In some embodiments, the opening 1906 may be positioned lower on the bottom fitment 1930 relative to other bottom fitments 1940. Lowering the position of the opening 1906 and horizontally aligning the opening 1906 relative to other bottom fitments 1940 may allow for more material to be dispensed from the liner, as may be seen by viewing FIGS. 19A and 19B. The embodiments shown in 19A and 19B may be used in conjunction with any of the embodiments described above.

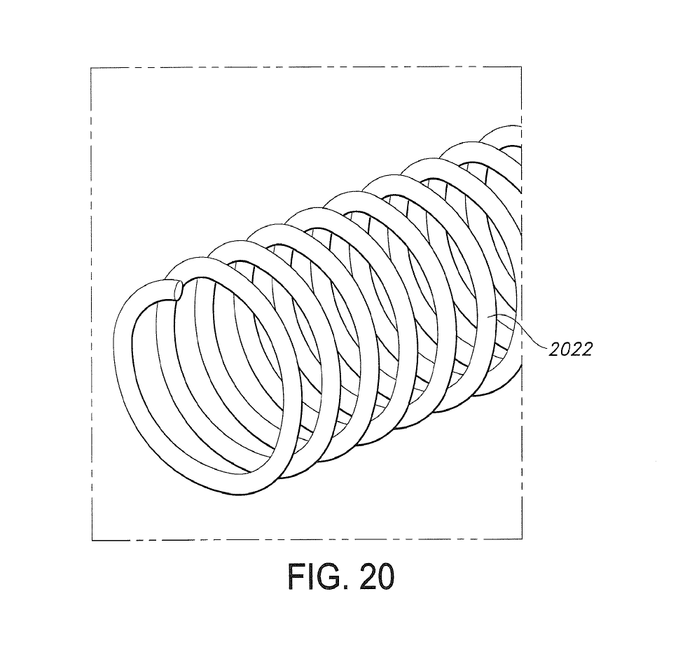

In yet another embodiment, the dip tube itself may allow for ease of movement. As shown in FIG. 20, in one embodiment, the dip tube 2022 may be a coil that may be comprised of a flexible material that may generally allow the dip tube to flex and bend in a variety of directions. The dip tube may be made of any suitable material. The dip tube 2022 of this embodiment may be used in conjunction with any of the fitments described herein. Further, any of the features of any of the fitments described herein may be combined in any suitable manner.

In some embodiments, as discussed above, the liner may come with the dip tube already assembled in the liner. In other embodiments, it may be possible to ship the liner empty without the dip tube attached to the liner. In such embodiments, the user may secure the dip tube to the liner. Because the dip tube would not be attached to the liner during shipping, the liner would not be stressed by the dip tube moving during packaging and/or shipping, for example.

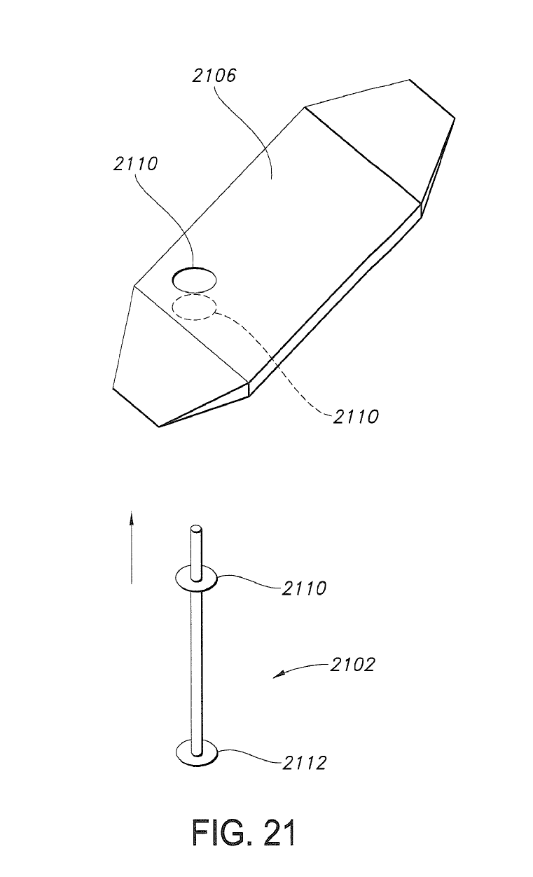

As may be seen in FIG. 21, in some embodiments a liner 2106 in a collapsed position may have a top opening 2104 that may align with a bottom opening 2108. During shipment, the openings 2104, 2108 may be covered with caps or covers, for example to maintain the sterility of the interior of the liner for example. When a user wishes to fill the liner, the user may attach the dip tube to the liner, generally as shown, in some embodiments. A user may assemble the dip tube subassembly 2122, which may include the tube 2102, a top connector 2110 that may connect to the top fitment of the liner and a bottom connector 2112 that may connect to the bottom fitment of the liner. Once assembled, the subassembly 2122 may be threaded inside the bag. Once assembled, the liner may be filled and used as described above.

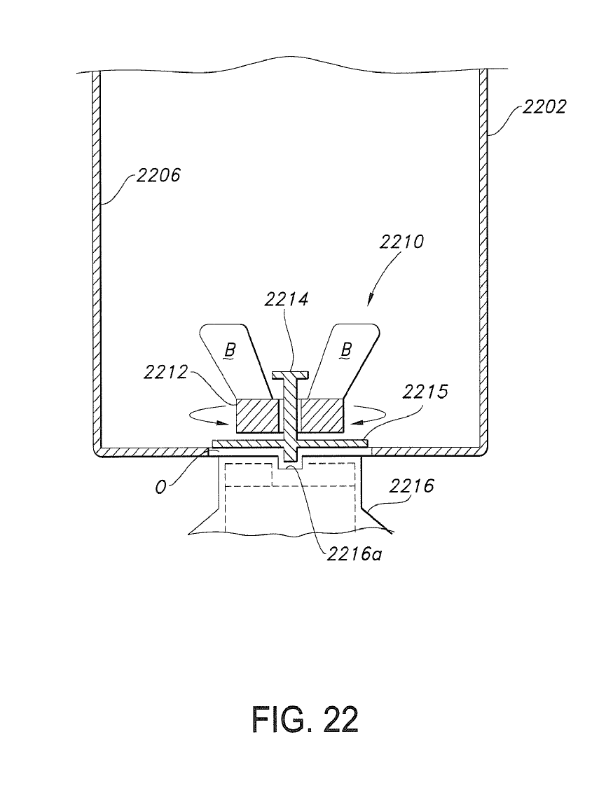

The system may also be adapted to provide for the direct agitation of the substance in the liner for a shipping and dispensing system, and in a manner that does not interfere with the desirable pressure dispense function. For example, as shown in FIG. 22, the liner 2206 for use with a shipping and dispensing system and within a container, such as the overpack 2202, may be arranged to include a mixer 2210 for mixing the substance in the liner prior to or during the pressure dispensing operation. In one embodiment, the mixer 2210 comprises a magnetic impeller 2212 including a plurality of blades B.

In this or other embodiments, a receiver, such as a post 2214 extending from a rigid seating plate 2215 providing a peripheral flange, may be connected to the liner 2206 (such as in an opening thereof formed along a bottom portion or wall) to receive and hold the impeller 2212 at a known location. This facilitates the relative positioning of an external motive device 2216 for levitating or rotating the magnetic impeller 2212 in order to agitate the substance in the liner 2206. The retention function also helps to prevent the mixer from interfering with the collapse of the liner 2206 during the fluid dispense operation.

Alignment of the motive device 2216 may be aided by the provision of an alignment device. For example, the device may comprise a locator projection coextensive with post 2214 for positioning in a corresponding recess 2216a in the motive device 2216. The full details of such an arrangement may be found in U.S. Pat. No. 7,481,572, the disclosure of which is incorporated herein by reference.

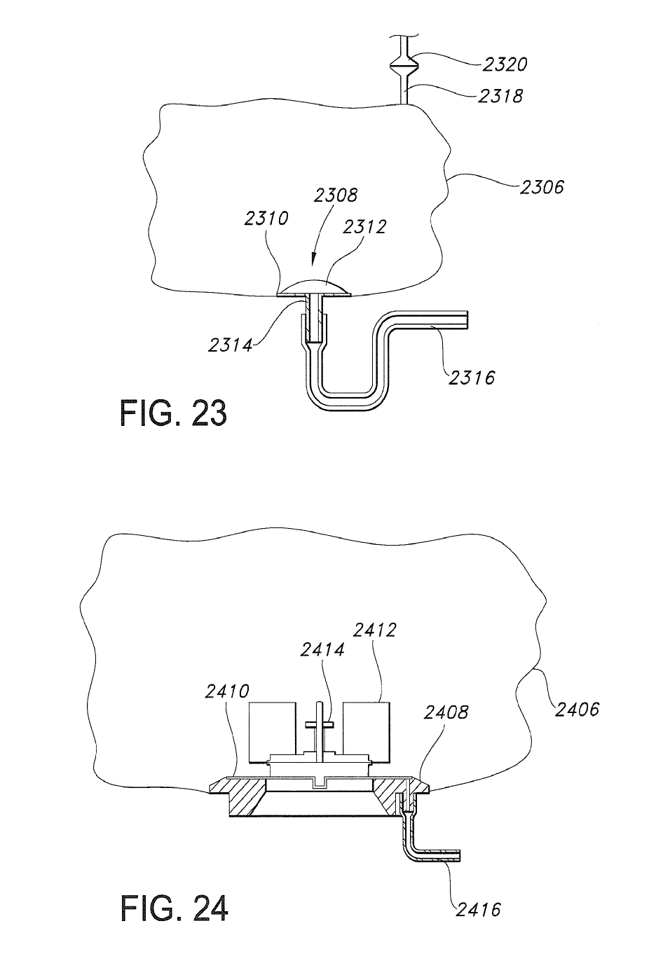

In some cases, the substance forming the contents of the liner may comprise biologically active agents or are otherwise in need of a supply of a gas, including oxygen. Accordingly, as shown in FIG. 23, it may also be desirable to provide the liner 2306 with a gas supply inlet, such as through a sparger 2308 for creating bubbles in a liquid contained in the liner. The sparger 2308 may couple directly to the sidewall of the liner 2306 and form an integral part thereof, as shown, or may be connected to a tube extending into the liner through a port (not shown). In the illustrated embodiment, the sparger 2308 comprises a rigid base 2310 connected to a permeable material 2312, such as a micro-perforated film. An external connector 2314 is provided for coupling with a source of gas, such as through a conduit 2316.

As should be appreciated, the addition of gas to the interior of the liner 2306 may require a manner of exhausting the gas as well. This may be achieved using a vent 2318. In order to maintain the desirable sterile condition of the liner 2306, the vent 2318 may be associated with a sterile filter 2320 or like mechanism for maintaining the aseptic condition of the fluid.

FIG. 24 shows one manner of providing the sparging and mixing functions in a single liner 2406. This may be achieved by providing a base 2408 including a sparger, such as in the form of an annular ring of a permeable material 2410, and further adapted for receiving a mixer, such as a magnetic impeller 2412. The impeller 2412 may be receive on a receiver, such as post 2414, in a manner that provides retention, yet relative movement to permit levitation and/or rotation as the result of a non-contact (e.g., magnetic) coupling with an external motive device (not shown). A conduit 2416 may be coupled to the base 2408 to supply the gas to the sparger, and may be connected to a gas source external to the associated overpack (not shown). The disclosure of U.S. Pat. No. 7,384,027is incorporated herein by reference in its entirety.

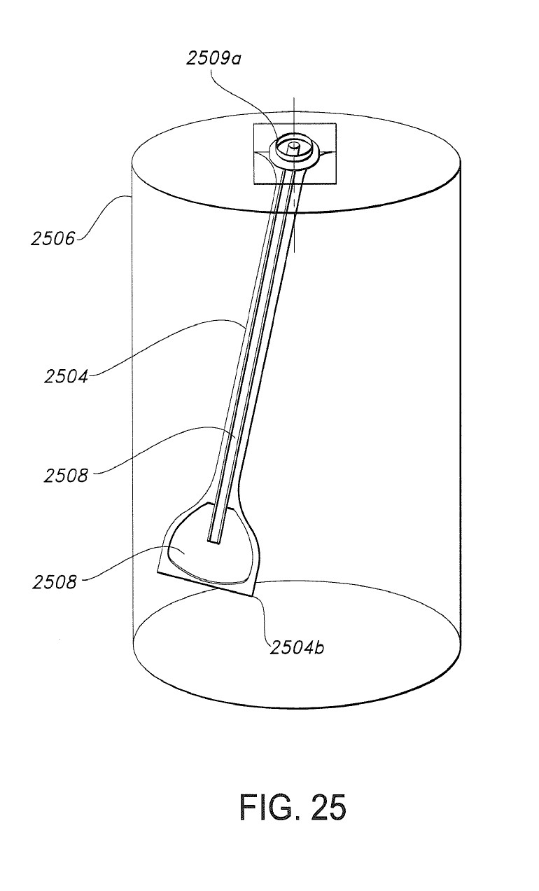

Another form of mixer is shown in FIG. 25. The mixer in this embodiment may comprise a flexible sleeve 2504. The sleeve 2504 may be connected to the liner 2506, such as along an upper portion thereof. In one embodiment, the sleeve 2504 includes an open end 2504a and a closed lower end 2504b. A rigid rod 2508 may be inserted into the open end 2504a and passed along the sleeve to connect with a paddle 2510 adjacent the closed end 2504b. Movement of the rod 2508 thus causes the non-rotational movement of the sleeve 2504 within the liner 2506 to agitate the fluid, without causing any breach of the sterile conditions.

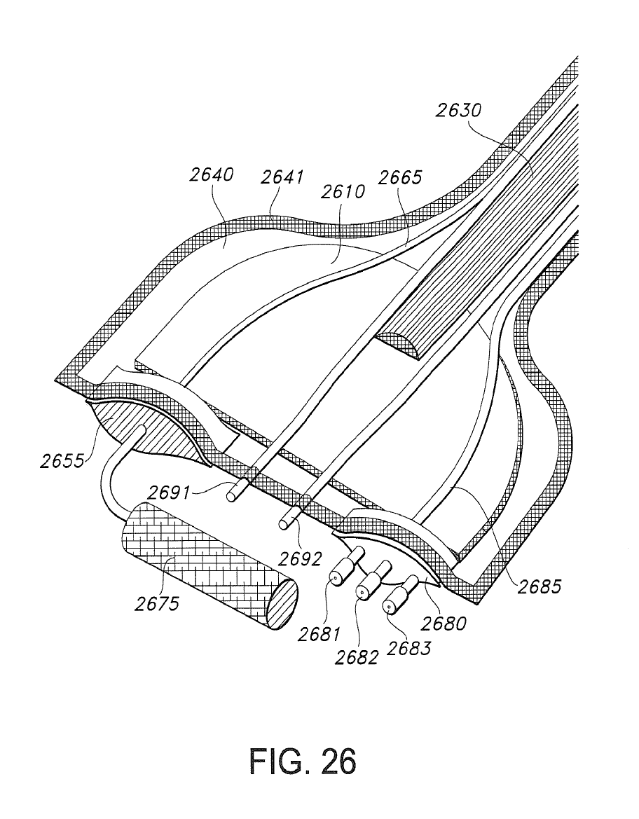

Functional elements may also be integrated with a mixer, such as the paddle/sleeve arrangement shown in FIG. 25 and as further described in U.S. Patent Application Publication 2010/0015696, the disclosure of which is incorporated by reference in its entirety. For example, FIG. 26 illustrates a mixing paddle 2610 and sleeve 2640 with a rod 2630 having a material addition conduit 2691, a material extraction conduit 2692 (e.g., for extracting periodic samples to be analyzed), and one or more sensors 2681-2683, such as a temperature sensor 2681, a pH sensor 2682, and an oxygen sensor 2683. However, it is also possible to provide the one or more sensors 2681-2683 in a manner that is independent of the mixer, such as by associating them directly with the liner of any embodiment described herein. The sensors may also be optical in nature, as described in U.S. Pat. No. 7,384,027, incorporated herein by reference.

As another example, a sparger 2675 may be provided in fluid communication with a gas supply conduit 2665 passing through a fitment 2655 disposed along a peripheral seam 2641 of the sleeve 2640. Yet another example of a functional element that could be provided to travel with a mixing paddle is a heat exchange element (not shown), which may include an electrically driven heat exchange device (e.g., a resistance heater or thermoelectric device) or a circulating fluid communicable with an external heat source or sink. One or more electrical conductors or fluid conduits (e.g., for conducting a heat exchange fluid) may be associated with such heat exchange device. By arranging functional elements to travel with the mixing paddle 2610, substantial flow rates of fluid relative to the functional elements (e.g., elements 2675, 2681-2683, 2691, 2692) are achieved. The motion and mixing action of the paddle tends to quickly eliminate local (positional) variation of fluid conditions.

Each functional element may include an associated interface. For example, with continued reference to FIG. 26, the sparger has an associated gas supply tube 2665 (and fitment 2655), the material addition conduit may include a material addition segment passing through the seam 2641, the material extraction conduit may include a material distraction segment passing through the seam 2641, and the sensors 2681-2683, which are mounted to a receptacle 2680 (or fitment) may include one or more associated electrical conductors 2685. Such interface elements may be routed through the sleeve; alternatively, if a sleeve is not provided, then such interface elements may be routed through or along the support rod, optionally disposed within a sheath (not shown). A plug or receptacle may be used any for each functional element or all functional elements to permit rapid connection and disconnection of desired components (e.g., spargers of different sizes, sensors of different types, heat exchangers of different capacity, etc.).

A further embodiment of a mixer is shown in FIG. 27. In this embodiment, a sleeve 2704 is connected to a liner 2706 positioned in an overpack 2702 and arranged such as in FIG. 1 for the provision of a pressure dispense function. The sleeve 2704 includes a magnet 2708 for forming a non-contact coupling with an external motive device 2724. The sleeve 2704 may be provided with blades 2704a, which may be flexible. The sleeve 2704 may have an open upper end adapted for slidably receiving the magnet 2708, including prior to being attached to the liner 2706.

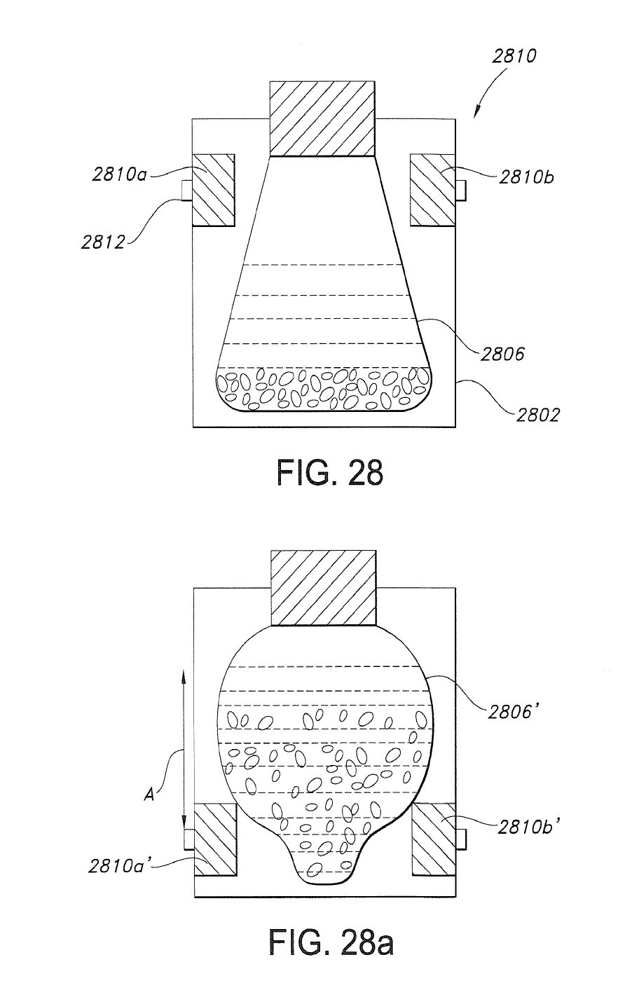

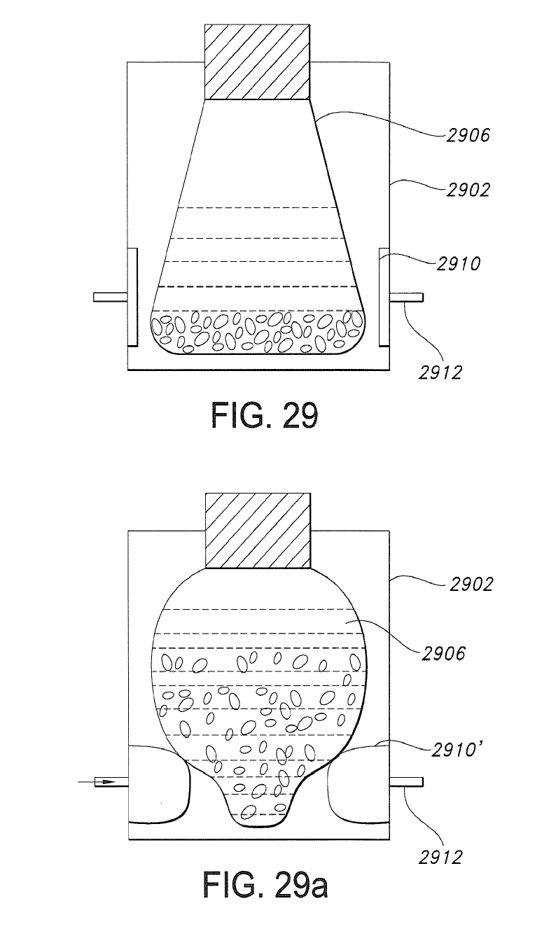

Another embodiment of a liner 2806 arranged in a container, such as overpack 2802, for use in a pressure dispense operation is described with reference to FIGS. 28 and 28a. This embodiment includes a mixer external to the interior compartment of the liner. For example, the mixer may take the form of an agitator 2810 configured to move within the space between the liner 2806 and the overpack 2802 (such as by being raised or lowered, but also possibly by being moved inwardly and outwardly toward the interior of the overpack). In the course of doing so, the agitator 2810 engages the outer surface of the liner 2806 and causes movement of the substance therein (compare liner 2806 in FIG. 28 and liner 2806′ in FIG. 29, noting action arrow A and projections 2810a′ and 2810b′ in the lower position and in contact with outer surfaces of the liner 2806′ to cause the mixing action).

The agitator 2810 may take various forms. For example, the agitator 2810 may comprise a pair of spaced projections 2810a, 2810b positioned on opposite lateral sides of the liner 2806, and projecting into the space so as to contact one or more outer surfaces of the liner 2806 within the overpack 2802 and agitate the substance. In one embodiment, the projections 2810a, 2810b contact different sides of the liner 2806, such as opposing sides, which provides a substantially equal, but opposite force to help agitate the substance.

The projections 2810a, 2810b as illustrated may project into the overpack a distance greater than the circumference of the liner in a given plane, and thereby cause the liner to at least partially collapse upon engaging it. A home position of the projections 2810a, 2810b may be provided where no contact with the liner 2806 is made, such as is shown in FIG. 28. Instead of a pair of projections 2810a, 2810b, the mixer may take other forms, including possibly a single, annular projection associated with a single actuator.

The projections 2810a, 2810b may be connected to actuators for causing movement relative to the liner 2806. For example, the actuators may comprise manual levers 2812 accessible from a location external to the overpack 2802, such as through a slot or like opening. Motive devices, such as linear actuators, may also be provided for automating the movement of the agitator 2810, such as projections 2810a, 2810b.

Yet another embodiment of a liner 2906 arranged in an overpack 2902 for use in a pressure dispense operation is described with reference to FIGS. 29 and 29a. In this embodiment, the mixer is also located in the space between the liner 2906 and the overpack 2902, and comprises an expandable structure, such as comprising one or more inflatable bladders 2910. The bladder or bladders 2910 may be attached along the inner surface of the overpack 2902 for engaging a bottom portion of the liner 2906 (such as along either the bottom wall, the sidewall, or both), and may be inflated and deflated through a port 2912. On inflation, the bladder 2910′ serves to displace the liner 2906′ (FIG. 29a) and thus agitate the contents. By alternately pressurizing and depressurizing the bladder(s), the agitation may occur continuously for a desired period of time, including prior to the dispensing of the contents from the sealed liner 2906 to ensure homogeneity.

In any of the foregoing embodiments of the packaging systems, an expandable or expanding foam material, or other expandable material, may be filled or injected into the space between two layers of the packaging systems, such as between an overpack and a liner or between two liners. During dispense of the contents of the packaging system, a fluid, such as but not limited to a gas, may be introduced into the space, such as through air flow ports or channels, causing the expandable material to expand. This expansion applies a pressure to the liner, expelling the contents thereof. The expandable foam material may be, but is not limited to, such materials as the expanding foam insulation material distributed under the name GREAT STUFF by The Dow Chemical Company.

In the foregoing description various embodiments of the invention have been presented for the purpose of illustration and description. They are not intended to be exhaustive or to limit the invention to the precise form disclosed. Obvious modifications or variations are possible in light of the above teachings. The embodiments were chosen and described to provide the best illustration of the principals of the invention and its practical application, and to enable one of ordinary skill in the art to utilize the invention in various embodiments and with various modifications as are suited to the particular use contemplated. All such modifications and variations are within the scope of the invention as determined by the appended claims when interpreted in accordance with the breadth they are fairly, legally, and equitably entitled.

1. A liner-based assembly for pressure dispensing a substantially sterile substance, the liner-based assembly comprising:
an overpack;
a liner disposed within the overpack and arranged for receiving the substantially sterile substance under sterile conditions, the liner configured to collapse when a pressure is applied to a space adjacent to the liner; and
a connector securable to at least one of the overpack or liner, the connector comprising at least one port for providing the liner with the substantially sterile substance and for dispensing the substantially sterile substance upon application of the pressure, the at least one port being operably connected with a quick connector configured for at least one of substantially aseptic filling or dispensing of substantially sterile substance.

2.-11. (canceled)

12. The liner-based assembly of claim 10, further including a vent for venting a gas from the liner.

13. (canceled)

14. The liner-based assembly of claim 1, wherein the space comprises an annular space between the liner and the overpack.

15. The liner-based assembly of claim 1, wherein the overpack includes a pressurizing inlet and a vent.

16. The liner-based assembly of claim 1, further including an expandable foam material in the space.

17. The liner-based assembly of claim 1, wherein the liner is flexible.

18. The liner-based assembly of claim 1, wherein the liner is semi-rigid.

19. The liner-based assembly of claim 1, wherein the liner is manufactured from a material selected to substantially maintain the sterility of the substance stored within the liner.

20. The liner-based assembly of claim 1, wherein the connector further comprises a pressurizing gas inlet for operably connecting with a pressure source for supplying the applied pressure in the space.

21. The liner-based assembly of claim 1, wherein the quick connector provides an aseptic connection.

22. The liner-based assembly of claim 1, wherein the connector comprises a port configured for both filling and dispensing of the substance.

23. The liner based-assembly of claim 1, wherein the connector comprises a first port for filling liner with the substance and a second port for dispensing the substance from the liner.

24. The liner-based assembly of claim 1, further comprising a dip tube having a first end operably secured to the liner by a top fitment located at a top portion of the liner and a second end operably secured to a bottom fitment located at a bottom of the liner.

25. The liner-based assembly of claim 24, wherein the bottom fitment operably secures the second end of the dip tube such that the second end is statically secured at the bottom of the liner.

26. The liner-based assembly of claim 24, wherein the bottom fitment is configured to permit the end of the dip tube attached thereto to move about at least one axis of motion.

27. The liner-based assembly of claim 1, wherein at least the liner is disposable.

28. A method for substantially sterile transport of a substantially sterile substance, the method comprising:
providing a liner-based assembly comprising an overpack and a liner disposed within the overpack, the liner configured to collapse when a pressure is applied to an annular space between the liner and the overpack; and
providing a connector securable to at least one of the overpack or liner, the connector comprising:
a first port operably connected with a quick connector configured for substantially aseptic filling of the liner;
wherein the first port is configured for substantially aseptic sealing after filling of the liner; and
wherein the connector is configured for substantially aseptic dispense of the substance of the liner via the first port after unsealing of the first port or via a second port.

29.-103. (canceled)

104. A method for mixing a substance in a liner partially filled with a substance and positioned in an overpack, while maintaining the substance under sterile conditions, comprising:
pressurizing a space between the liner and the overpack to compress the liner; and
at least partially releasing the pressure from the space to relax the liner.

105.-110. (canceled)
